(19) United States
(12) Patent Application Publication
(10) Pub. No.: US 2023/0048420 A1
(43) Pub. Date: Feb. 16, 2023

(54) LASER PROCESSING DEVICE AND METHOD FOR LASER-PROCESSING A WORKPIECE

(71) Applicant: PULSAR PHOTONICS GmbH, Herzogenrath (DE)

(72) Inventors: Max Funck, Potsdam (DE); Stephan Eifel, Köln (DE); Daniel Keller, Aachen (DE); Joachim Ryll, Roetgen (DE); Jens Holtkamp, Wassenberg (DE)

(21) Appl. No.: 17/796,548

(22) PCT Filed: Jan. 27, 2021
(86) PCT No.: PCT/EP2021/051823

§ 371 Date: Jul. 29, 2022

(30) Foreign Application Priority Data
Jan. 29, 2020 (DE) 10 2020 1020 77.5
Mar. 20, 2020 (DE) 10 2020 107 760.2

(51) Int. Cl. B23K 26/06; B23K 26/067

(52) U.S. Cl. CPC B23K 26/0643; B23K 26/0648; B23K 26/067

(57) ABSTRACT

A laser-machining device comprising a laser-radiation source to generate a laser beam and emit it along an optical path; a beam-splitting unit downstream of the laser-radiation source designed to split the laser beam into a bundle of partial beams; an optical control unit downstream of the beam-splitting unit comprising a reflective optical functional unit formed by an array of reflective microscanners, wherein the optical control unit is designed to select any desired number of partial beams in any desired spatial combination from the bundle of partial beams and direct them onto a workpiece, and to position and/or move at least one of those partial beams within a specified partial-beam scanning region of the respective partial beam using the microscanner of the array of microscanners assigned to the respective partial beam, and methods for laser machining a workpiece.

The present invention relates to a laser processing device and a method for laser-processing a workpiece at predetermined processing sites using the laser processing device according to the invention.

For example, the above-mentioned processing sites may be flaws of a workpiece that are repaired or corrected by means of laser-processing. In this context, the above-mentioned workpieces may be displays or display surfaces, for instance. Moreover, the laser processing device proposed with the invention or the method proposed with the invention may be used for processing a workpiece by way of a “Laser Induced Forward Transfer” (LIFT) process, i.e. for processing predetermined processing sites of a workpiece. Another area of use of the invention is laser drilling of circuit boards for producing through-connections (via bores, blind via holes or through-via holes). In the process, the workpiece is provided at different sites with bores.

The advantages accompanying laser drilling as compared with other drilling methods particularly lie in the fact that the drilling process can be carried out in a contactless manner and free from wear, with high precision and very rapidly. Moreover, even the smallest diameters and high aspect ratios are attainable. For example, bore diameters of up to 20 μm can be formed. Moreover, the bores formed by means of laser drilling generally have sharp edges and freedom from material at the entry and exit of the bore hole.

In particular, percussion drilling and trepanning are used in laser drilling. The number of laser pulses required for forming the bore hole increases in the above-mentioned order. In percussion drilling, the bore is formed by applying a series of successive individual pulses to the site to be processed. If the laser beam is guided across the workpiece surface along a circular contour and the hole is cut out by the pulsed laser beam, this is referred to as trepanning. Thus, the method corresponds to percussion drilling with subsequent circular cutting. The present invention may relate to all of the above-described variants of laser drilling.

As was already mentioned, the present invention may be used, in particular, for forming laser bores in a workpiece. The laser drilling method is suitable—as was also already mentioned—particularly for forming through-connections (so-called via bores) between the conductor path layers of a circuit board. Circuit boards frequently have a multi-layer structure and comprise an upper and a lower electrically conductive metal layer, which sandwich an electrically insulating intermediate layer consisting of plastic, ceramics or a composite material (e.g. FR4, which includes an epoxy resin and glass fiber fabrics). Using laser radiation, a bore can be formed in a predetermined processing region of the circuit board, i.e., both the metal layers and the insulating intermediate layer can be removed by means of laser drilling. The via bore may penetrate the workpiece completely (so-called through via holes); however, a via bore may also be formed such that only one of the metal layers and the intermediate layer are removed in the region of the bore (so-called blind via holes). It may be expressly emphasized here that the invention may be intended for forming both through via holes and blind via holes. Laser drilling is suitable both for processing circuit boards with a thickness of one to several millimeters, however, laser bores may also be implemented, as it were, in thin circuit boards with a thickness of a few micrometers, e.g. 50-60 μm. Bores may also be formed in flexible films by means of laser processing. In this case, the film thickness may vary from a few micrometers to the millimeter range, which does not, however, preclude the processing of such a film with the device of the present invention or the method of the present invention. Incidentally, circuit boards may also be configured as films. The latter can also be processed with the device according to the invention or the method.

However, other uses, in which the laser processing device proposed with the invention or the method proposed with the invention are employed, are not excluded.

A possible area of use of the laser processing device proposed in accordance with the invention or the method proposed in accordance with the invention relates to the fabrication of graphic displays; OLED displays (organic light emitting diode) or mini-LED displays may be cited here as examples. A fabrication-related formation of flaws may occur during fabrication. Within the framework of the terminology used in the present case, flaws are to be understood to be “processing sites”. These flaws may occur at certain pixels of the display, e.g. in the electrical contacting. Unwanted deviations with regard to the surface structure (e.g. homogeneity, layer thickness, planarity) may be present in those flawed regions.

Since such flaws are usually not distributed in a homogeneous fashion on the display surface, and frequently occur at a plurality of display pixels, it is desirable to subject the flaws to a repair or correction process which, on the one hand, permits a simultaneous processing of several flaws and, on the other hand, can be adopted flexibly to a flaw distribution present on a certain display. For such a flaw correction, laser processing techniques are particularly suitable, because a pixel-by-pixel, high-resolution and at the same time rapid (removing) processing is ensured with them. Processing such flaws with individual laser beams is known from the prior art, but accompanied by disadvantages as regards process control and process duration. Accordingly, methods permitting the parallel processing of several flaws at once are of particular interest. A parallel processing provided by beam selection is known from U.S. Pat. No. 9,592,570 B2, but here only that individual spot lines or columns may be selected.

It may be emphasized expressly at this point that the present invention is not only suitable for processing or repairing flaws of a display; in principle, any workpieces or materials containing flaws may be processed with the laser processing device according to the invention or the associated method, which permit removal (ablation) processing. At the same time, the present invention is—as mentioned in the introduction—suitable for forming laser bores at predetermined or desired processing sites of a workpiece, e.g. a circuit board. Thus, the processed material has to be susceptible to ablation by laser radiation. Moreover, the present invention is suitable for use in the LIFT method already mentioned above. In the process, pulsed laser beams are directed towards a coated substrate (e.g. in the point-and-shoot mode) in order to transfer material onto a second substrate in the direction of the laser radiation. LIFT methods may be used for the production of thermoelectric transfer materials, polymers and for printing on substrates. Accordingly, the “processing sites”, within the context of the invention, may also be understood to be such sites of a first substrate (of a workpiece within the sense of the invention) at which a material transfer onto a second substrate (which is in each case disposed so as to be coplanar with the first substrate) is to be carried out using the LIFT method, in particular those sites of a first substrate (workpiece) to be irradiated with laser beams. Depending on the requirements for the workpiece to be processed, a predetermined processing pattern (transfer pattern) may be formed by means of the LIFT method at defined processing sites or pixels of a workpiece. Within the context of the present invention, partial beams of a split laser beam may be directed in the point-and-shoot mode towards predetermined processing sites of a workpiece.

Over the course of the continuously progressing development of laser technology, using lasers for processing various materials has been known for many years, e.g. in the area of the production of electronic components, circuit boards or display elements.

Currently, laser radiation with a Gaussian intensity distribution is most frequently used in material processing using laser radiation (e.g. in laser ablation, laser welding, laser soldering, laser cleaning, laser drilling, laser sintering or laser melting). However, the adaptation of the intensity distribution in the processing region of the workpiece to the processing specifically at hand or the material to be processed is advantageous for many of these processes. Therefore, optimizations of the laser processes by altering the intensity distribution in the processing plane are increasingly investigated. In order to adapt the intensity distribution, it is known to subject the laser radiation generated by a laser radiation source to a beam shaping process, which offers a considerable optimization potential for the development of the laser process.

As was already mentioned, the laser radiation generated by a laser radiation source typically has a Gaussian intensity distribution or Gaussian beam profile with respect to its beam cross section. However, by means of suitable beam shaping techniques, laser beams may be shaped while altering the intensity distribution. In order to shape an intensity distribution of a laser beam, either its phase, amplitude or both quantities at the same time may be modulated. Accordingly, phase modulators, amplitude modulators or phase and amplitude modulators are used, e.g. in the form of diffractive beam shapers. Diffractive beam shapers (Diffractive Optical Elements, DOE) for adjusting far-field intensities may be produced as phase elements from glass or other transparent materials.

Moreover, an intensity distribution may be shaped by refraction and reflection on optical elements. Accordingly, shaped refractive or reflective elements, such as deformed or deformable mirrors, or transmissive elements with a geometric deformation of the surface or shape are used. In the process, the individual partial beams of a laser beam incident upon the refractive or reflective optical element are incident upon surfaces that are differently curved in each case, and are reflected or refracted by them. Having been shaped by the element, the totality of the partial beams forms a new intensity distribution. One example for such a beam shaping process is the reshaping of a Gaussian laser beam into a top-hat-shaped laser beam, also referred to as Gauss-to-Top-Hat beam shaper. Such a beam shaper may also be used in the laser processing device according to the invention. The geometric deformation of the surface necessary for beam shaping may be calculated by means of analytical, numerical or iterative processes (e.g. superposition of Zernike polynomials).

However, diffractive beam shaping elements may also be configured as beam splitters (within the context of the present invention, the function of the DOEs as a beam splitter is crucial). In this connection, binary gratings or blazed gratings may be mentioned as examples. Because of the geometry of the diffractive structure, a constructive interference in the spatial frequency space (k-space) is produced on a rectangular grating. Various patterns of active orders of diffraction (constructive interference) can be realized by means of numerical algorithms. In this case, the angular separation of the orders of diffraction has to be large enough compared to the far-field divergence of the incident laser radiation, because otherwise interference disturbs the pattern of the active orders of diffraction.

However, such non-adaptable DOEs are increasingly replaced with programmable modulation units for dynamically shaping the laser radiation. The intensity distribution in space and time of laser radiation emitted by a laser radiation source can be adjusted with programmable modulation units. Such programmable modulation units are also referred to as “spatial light modulators (SLM)”. In principle, spatial light modulators may also be used for beam splitting.

Various laser radiation sources may be used in laser processing. For precise material removal, a focusing that is as small as possible should be sought, with as short-wave a laser as possible. As standard, nanosecond lasers in the IR, VIS or UV ranges are used today. For efficient material processing, laser radiation with a wavelength must be used that is absorbed by the material to be removed from the workpiece to be processed. Laser radiation with wavelengths in the near infrared and VIS ranges are not very suitable for some materials, unless short pulse durations in the picosecond and femtosecond ranges are used.

So-called solid-state lasers, particularly Nd:YAG lasers, are frequently used for laser processing, for instance. These lasers can be adapted precisely to the respective application with respect to the obtainable pulse duration, pulse energy and wavelength.

Using laser radiation with higher medium powers and applying it to the workpiece in the form of laser spots is a fundamental challenge of the laser processing of workpieces. This is inhibited by heat-related effects, e.g. heat accumulation in the workpiece. To avoid this, the generated laser power may either be extensively and rapidly distributed on the workpiece (e.g. by rapid scanning), or the power is directed to several processing sites of the workpiece - e.g. in the form of beam splitting. The present invention utilizes both options. In this regard, it is known to reflect laser radiation on mirrors and to deflect it to certain sites of a workpiece surface to be processed. An assembly of several such mirrors can be combined in a unit and form a mirror scanner. For example, galvanometrically driven mirror scanners (galvanometer scanners) are known, whose associated mirrors can be rotated by a defined angle by means of a rotary drive. In this way, a laser beam incident upon such a mirror can be directed towards different sites of the workpiece.

As was already mentioned, laser processing techniques permitting the parallel processing of workpieces are generally known. The laser processing devices used for this purpose may be referred to as multi-beam systems, particularly because they are based on the splitting of a laser beam generated by a laser radiation source into a plurality of partial beams. Thus, the workpiece is not processed with the initial beam generated by the laser radiation source but with the partial beams. The partial beams projected onto the workpiece are in this case imaged on the workpiece in a defined spot pattern. In the known processing methods, partial beams, and thus the spot pattern, are moved simultaneously and synchronously across the workpiece to be processed. Though it is known in this case to couple out individual partial beams at various sites of the workpiece and to adapt the spot pattern to the processing sites at hand, basically, however, only periodic structures can be processed or periodic processing patterns realized with such a process.

In addition to the processing of periodic structures or processing patterns, non-periodic or partially periodic structures are frequently found particularly in areas of electronics (i.e., non-periodic or partially periodic processing sites are present), which cannot be processed, or only to an insufficient extent, with the known laser processing techniques of multi-beam processing. The advantage of such multi-beam processing lies in enabling the multiplication of the processing speed by parallel processing. Accordingly, there is a great demand for extending this advantage also to the multi-beam laser processing of non-periodic structures.

Based on the preceding explanations, it is the object of the present invention to provide a laser processing device and a method for laser-processing a workpiece, with which a rapid and parallel processing of several processing sites of the workpiece even in the case of a non-periodic or partially periodic distribution of processing sites on the workpiece is made possible.

The aforementioned object is achieved with a device having the features of patent claim 1 and with a method having the features of patent claim 32.

The laser processing device on which the invention is based is provided for processing predetermined processing sites of a workpiece. The laser processing device comprises

a laser radiation source configured for generating a laser beam and emitting it along an optical path in the direction of the workpiece;

a beam splitting unit, which is disposed downstream of the laser radiation source in the beam direction and configured for splitting the laser beam into a bundle of partial beams;

an optical control unit, which is disposed downstream of the beam splitting unit in the beam direction and which comprises a reflective optical functional unit formed of an array of reflective microscanners, the optical control unit being configured

to select from the bundle of partial beams an arbitrary number of partial beams in an arbitrary spatial combination and direct them towards the workpiece,

to position and/or move, within a predetermined partial beam scanning region of the respective partial beam, at least one, preferably each one, of the partial beams directed towards the workpiece using a microscanner of the array of microscanners assigned to the respective partial beam.

Preferably, the microscanners are each configured to change or manipulate in two independent coordinate directions a beam trajectory of a partial beam incident upon a respective microscanner and reflected there. With a laser processing device according to the invention, complex folds of the partial beam in the beam path can be avoided. Moreover, the arrangement of the microscanner in an array permits a dense packing, whereby the structure of the laser processing device as a whole can be made more compact because the beam tracks, given a small bundle divergence, would otherwise become very long. Thus, compared to similar systems known from the prior art, the present structure of the laser processing device is considerably more compact. Moreover, individual components are easier to adjust. Above all, it is possible to realize 2D distributions of laser spots in combination with an individual scanning function for each partial beam in a particularly simple manner. Furthermore, the optical sub-assemblies are ordered in clear-cut groups and not distributed across the structure in an arbitrary manner, which makes the laser processing device considerably more robust and thus more reliable.

In the sense of the invention, an “array” of microscanners does not necessarily have to be understood to be an arrangement of microscanners within a common microscanner plane; other “arrangements” of the microscanners in three-dimensional space or within one or more planes may also be understood to constitute an “array”.

First, it must be noted that, because of the (at least partially) reflective structure, the laser processing device according to the invention requires a smaller construction space than comparable laser processing devices configured to be purely transmissive.

Optionally, the laser processing device may further include a beam positioning unit, particularly in the form of a galvanometer scanner, a pivot scanner or a two-axis single mirror scanner, which is configured for carrying out a rough positioning process, relative to the workpiece, of the partial beams directed towards the workpiece, namely by positioning a master scanning region including the partial beam scanning regions relative to the workpiece, and/or is configured for moving, preferably synchronously and simultaneously, the partial beams directed towards the workpiece across the workpiece, namely by moving the master scanning region including the partial beam scanning regions relative to the workpiece.

The master scanning region is to be understood to be a region spanned in space on the workpiece which includes the maximum number of partial beams on the workpiece that can be generated by the beam splitting unit; in this case, the size of the master scanning region is substantially determined by the splitting of the laser beam into partial beams by the beam splitting unit. Moreover, the master scanning region includes all partial beam scanning regions of the maximum number of partial beams imaged on the workpiece. Depending on the application, however, it may be provided that only a predetermined number of partial beams are actually directed onto the workpiece. A partial beam scanning region is to be understood to be the region in which a respective partial beam can be individually positioned and/or moved on the workpiece, e.g. using the optical control unit, in particular the reflective optical functional unit. In this case, the partial beam scanning regions have a smaller size than the master scanning region. The partial beam scanning regions situated within the master scanning region may be spaced apart from each other, be adjacent to each other, or overlap. The partial beams located within the master scanning region and directed towards the workpiece may be shifted across the workpiece together (preferably simultaneously and synchronously); thus, the master scanning region can be directed (scanned) towards different sites of the workpiece. Thus, a respective partial beam may, for example, undergo two scanning or positioning movements, namely when the master scanning region is aligned on the workpiece and during the positioning or moving within the respective partial beam scanning region.

As was explained above, the beam positioning unit may be an “optional” constituent element of the laser processing device according to the invention. Even without a beam positioning unit, different sites of a workpiece can be processed with the laser processing device according to the invention, for example by a workpiece to be processed being disposed in a workpiece holder (e.g. on an xy-table) and positioned relative to the laser processing device depending on the site to be processed. The laser processing device may also be positioned and/or moved relative to a stationarily arranged workpiece, e.g. by means of a corresponding assembly of axes. At the respective sites, the partial beams directed towards the workpiece can then nevertheless be positioned or moved within the respective partial beam scanning regions. Moreover, it is possible to approach the sites of the workpiece to be processed with a combined feed of the workpiece relative to the laser processing device on the one hand and, on the other hand, a positioning of the partial beams located within the master scanning region relative to the workpiece.

A laser processing device including a beam positioning unit makes it possible to simultaneously and synchronously move across the workpiece the partial beams or associated laser spots directed towards the workpiece, for the purposes of positioning and processing. On the one hand, the partial beams located within the master scanning regions or the associated laser spots can thus be shifted and positioned relative to the workpiece. However, simultaneous and synchronous (scanning) processing of different sites of the workpiece is thus also made possible. Alternatively, however, individual partial beams may undergo a scanning movement within the respective partial beam scanning regions—independent of the scanning movement carried out by the beam positioning unit. However, the laser processing device can readily also be used for the parallel point-and-shoot processing of several processing sites. During point-and-shoot processing—as the term as such already expresses—a laser beam (in this case a predetermined number of partial beams) is directed (“point”) towards different processing sites of the workpiece. By applying (“shoot”) laser pulses, processing is carried out at these sites. A positioning or processing movement of the laser spots during laser processing (application of laser pulses) on the workpiece is not absolutely necessary; a single alignment process may suffice (depending on the processing task). Thus, different sites of the workpiece may also be processed by means of point-and-shoot processing. Because in this case, the workpiece can be positioned relative to the laser processing device, or vice versa, between the point-and-shoot steps, in order to direct the laser spots towards different sites to be processed. The same may also be done with a beam positioning unit, with which the spot pattern located within the master scanning region may be re-orientated on the workpiece after the processing has been completed at a site of the workpiece.

A crucial advantage of the present invention is the fact that non-periodic or partially periodic processing patterns (i.e. processing sites distributed on the workpiece in a non-periodic or partially periodic manner) can be processed with the laser processing device according to the invention, and in this case either by means of a movement of the partial beams directed towards the workpiece, or of the associated laser spots, being executed in a simultaneous and synchronous manner, or by way of the above-mentioned point-and-shoot processing. With the laser processing device according to the invention, the individual partial beams of a multi-beam system directed towards the workpiece may, on the one hand, be individually positioned on the workpiece in a partial beam scanning region, on the other hand, the number and distribution in space of the partial beams in a master scanning region (the latter is determined by the lateral extent of a region including the partial beams directed towards the workpiece) may be specifically adjusted.

Workpieces with a defined or predetermined pattern of flaws, laser bores or other sites to be processed (in this case, the flaws, laser bores or other sites to be processed may be arranged in a periodic, non-periodic or partially periodic manner) can be processed with greater flexibility using the laser processing device according to the invention. Accordingly, the term “processing sites” shall generally be used hereinafter, wherein “processing sites” may mean flaws, laser bores as well as other processing sites (e.g. the sites to be processed using the LIFT method, or the sites to be processed during laser drilling). In both cases, the workpiece to be processed may have a periodic, non-periodic or partially periodic configuration with regard to the processing sites on the workpiece surface, i.e. the processing sites on the surface are arranged in a surface-like periodic, non-periodic or partially periodic pattern with respect to a two-dimensional top view. Thus, the laser processing device according to the invention permits a scanning processing of a workpiece, i.e. the partial beams are moved across the workpiece by means of a beam positioning unit or using the optical control unit, while the laser pulses are applied to the workpiece.

The bundle of partial beams provided by the beam splitting unit of the laser processing device at first also preferably provides a periodic arrangement of partial beams. Instead of the periodically arranged distributions of the partial beams, the bundle of partial beams may also include an arbitrary spatial combination of partial beams, or such a free arrangement in space may be set with the beam splitting unit. It is only with the optical control unit that various partial beams can be deflected from the optical path, so that the partial beams can be selected such that a desired number of partial beams (or associated laser spots) is imaged on the workpiece in an arbitrary arrangement in space with respect to a spot pattern imaged on the workpiece. If a bundle of partial beams can be generated from the laser beam by means of the beam splitting unit, which basically enables the imaging on the workpiece of laser spots disposed in a spot matrix, e.g. a 4×4 spot matrix of laser spots, it is possible to determine, by means of the optical control unit, whether a certain partial beam or laser spot of the 4×4 spot matrix is actually transferred in the direction of the workpiece and imaged on the workpiece. Accordingly, it is possible to freely determine which of the partial beams providing the spot matrix consisting of 4×4 laser spots is actually imaged on the workpiece in the form of a laser spot; that is, a spatial arrangement or pattern of the laser spot is freely adjustable in any permutation, taking into account the basic matrix predefined by the beam splitting unit. In contrast to the prior art described in the introduction, not only can individual lines or columns of a spot matrix imaged on the workpiece (or the corresponding partial beams) be selected with the present invention, but arbitrary permutations of an m x n matrix of laser spots (or associated partial beams). It is not necessary to commit to a certain spatial pattern or a number of the partial beams; rather, any partial beams of the bundle of partial beams may be selected and transferred in the direction of the workpiece by the optical control unit. On the one hand, the laser processing device proposed in the present case permits a parallel processing of different processing sites within a master scanning region, on the other hand, it also permits a capability of individually positioning each partial beam in a partial beam scanning region, wherein the partial beam scanning region comprises a smaller lateral extent than the aforementioned master scanning region. Thus, the master scanning region includes a number of partial beam scanning regions that corresponds to the number of the partial beams directed towards the workpiece.

Depending on the size of the site to be processed, a single positioning of the workpiece relative to the laser processing device may be sufficient, for example in the case in which the region including the processing sites is smaller than the master scanning region accessible with the laser processing device, i.e. the region that the laser spots are capable of accessing through positioning by means of the beam positioning unit (without a relative displacement between the workpiece and the laser processing device). For such a preferred embodiment of the invention (i.e. the possibility of selecting the master scanning region to be as large as possible), however, the system has to be capable of compensating the distortion of an objective (e.g. of an F-theta objective), which is also a part of the laser processing device, which in the present case is made possible by the laser processing device according to the invention or the method specified herein. This will be explained in more detail later.

If, however, the region of the workpiece to be processed is larger than the master scanning region, it is necessary to calculate a processing path or displacement path relating to the relative displacement between the workpiece and the laser processing device. The displacement path may include a plurality of different processing positions (i.e. relative positions between the workpiece and the laser processing device). The required number of processing positions corresponds to the number of the required processing steps. After the workpiece has been positioned relative to the laser processing device (in accordance with one of the processing positions), the number and position in space of the laser spots or partial beams imaged on the workpiece is determined based on the number and arrangement (i.e. the patterns) of the processing sites present in this processing region. In the case of non-periodic or partially periodic patterns of processing sites, an individual positioning process of individual or several partial beams may be carried out additionally. In the process, the optical control unit permits an individual and independent positioning of all the partial beams within a predetermined partial beam scanning region. Thus, the partial beams can be directed exactly towards the processing site of the workpiece even in the case of non-periodic or partially periodic processing patterns. Moreover, the optical control unit permits the adjustment of an individual movement (i.e. a scanning) of the partial beams directed towards the workpiece within the partial beam scanning region. Thus, the partial beams located within the master scanning region can first be roughly positioned or roughly scanned relative to the workpiece by means of the beam positioning unit; moreover, the partial beams directed towards the workpiece can be individually positioned (fine positioning) or moved within a partial beam scanning region using the optical control unit. It may be emphasized in this case that a rough positioning process does not at all mean that the resolution during the positioning process is low. Rather, a very exact positioning process may be carried out already during the rough positioning process (e.g. using the beam positioning unit). For example, the rough positioning process may also be understood in the sense of a “primary positioning” of the partial beams or associated laser spots imaged on the workpiece, which can then be followed by a fine positioning process (which may be considered a further positioning process, individual positioning process or secondary positioning process) of the partial beams or associated laser spots. A “fine positioning process”, however, does not necessarily mean that the positioning is more exact or takes place with a greater spatial resolution.

Based on an input data set reflecting the processing sites present or predetermined on the workpiece, or the distribution thereof in space, the necessary processing path, the number of processing steps and the number and position of laser spots or partial beams imaged on the workpiece, which are required in the individual processing steps for processing the processing sites present there, can be determined. The aforementioned determination can be carried out, for example, under the premise of a process control or processing that is as rapid or efficient as possible.

As was already explained, the laser processing device according to the invention comprises a laser radiation source configured for generating a laser beam and emitting it along an optical path in the direction of the workpiece. Between the laser radiation source and the workpiece, the emitted laser beam can pass through optical components, be reflected, refracted, split or deflected thereon. The generated and emitted laser beam may in the present case be understood to be a continuous laser beam, but in particular a laser pulse. Preferably, short pulse or ultrashort pulse lasers may be used as laser radiation sources in the laser processing device proposed with the invention. In principle, using continuous wave (cw) lasers as a laser radiation source may also be conceivable.

According to the invention, the device further comprises a beam splitting unit, which is disposed downstream of the laser radiation source in the beam direction. It is configured for splitting the laser beam into a bundle of partial beams. In this case, the partial beams are distributed in a predetermined spatial pattern. Starting from the laser radiation source, a collimated laser beam thus hits the beam splitting unit. The beam splitting unit splits the laser beam into a bundle of identical partial beams that each have a defined angle to one another.

In addition, a beam shaping element may be provided between the laser radiation source and the beam splitting unit, with which, in combination with the beam splitting unit, a plurality of partial beams with a predetermined intensity distribution, e.g. a top-hat intensity distribution or ring-shaped intensity distribution, can be generated on the workpiece from a laser beam with a Gaussian intensity distribution. As a result, a multi-top-hat pattern of laser spots can be generated on the workpiece.

In this context, the term “beam direction” relates to the course of the laser beam. The indication of the beam splitting unit being “downstream” of the laser radiation source in the beam direction means that, along the optical path, the beam splitting unit is disposed behind the laser radiation source. Thus, the laser beam is first generated and only then enters the beam splitting unit or hits the latter. However, the use herein of the term “beam direction” does not exclude that the partial beams pass through individual optical components of the laser processing device multiple times.

The beam splitting unit may be, for example, a diffractive optical element (DOE). With respect to the details in this regard, reference is made to the introductory part of the description. Basically, using a “spatial light modulator”, which is known in principle from the prior art, as a beam splitting unit is conceivable, as long as beam splitting is ensured with the latter. A spatial light modulator is to be understood to be an optical component that varies the phase and/or amplitude of a laser beam locally, depending on the location. An incoming laser beam is phase- and/or amplitude-modulated by means of the spatial light modulator. Spatial light modulator for beam transmission are known from the prior art, which locally generate a phase retardation in a laser beam passing through the spatial light modulator. Moreover, spatial light modulators are known which locally generate an amplitude attenuation in a laser beam passing through the spatial light modulator. Both types of spatial light modulator act as diffractive elements causing diffraction images behind them that depend on the exact arrangement in space of the retarding or attenuating regions. The diffraction image, i.e. the beams of different orders underlying the diffraction image, may also be considered as partial beams in the sense of the present invention. However, it may be emphasized that the use of a DOE-based beam splitting unit is preferred according to the invention.

Moreover, variable spatial light modulators are known from the prior art, in which the intensity distribution of the modulated laser beam resulting on the workpiece can be adjusted. Such variable spatial light modulators may also be based on a locally varying phase retardation and/or amplitude attenuation. As a rule, beams are not passed through such spatial light modulators, but they are used in a reflecting configuration. As an example, mention may be made of spatial light modulators that are based on a reflection of laser radiation on a semiconductor surface with a liquid crystal layer disposed in front thereof. In the process, the birefringent properties of the liquid crystal layer can be locally adjusted in a targeted manner, e.g. by applying an electric field by means of micro-structured electrodes. Such spatial light modulators are sold by Hamamatsu under the name LCOS (“Liquid Crystal on Silicon”) spatial light modulator. Moreover, transmitting variable spatial light modulators are also known; they are sold, for example, by Jenoptik under the name “Flüssigkristall-Lichtmodulatoren Spatial Light Modulator-S” (liquid crystal light modulator spatial light modulator-S). Diffraction images generated with such variable spatial light modulators may also be considered as partial beams within the sense of the invention; however, the above-described variant of the embodiment of the beam splitting unit in the form of a diffractive beam splitter is to be preferred.

Moreover, mention may be made of amplitude-modulated variable spatial light modulators, which are based on micro-mechanical micromirror arrays. The individually controllable micromirrors permit specifically “masking out” regions in space from the cross section of a laser beam. This results in a diffraction image by refraction of the incident laser radiation on a “grating” in a reflection arrangement. In principle, diffraction images generated in this manner may also be considered partial beams in the sense of the present invention.

As was already mentioned, an arbitrary number of partial beams in an arbitrary spatial combination can be selected from the bundle of partial beams and directed towards the workpiece with the optical control unit that is also a part of the laser processing device. In the process, a first number of partial beams can be transferred along the optical path in the direction of the workpiece. Moreover, a second number of the partial beams can be deflected or absorbed from the optical path by a corresponding component of the optical control unit or a beam selecting unit, which means that the second number of partial beams do not hit the workpiece. The quantity of the first and second number (i.e. of the partial beams transferred in the direction of the workpiece and of the partial beams deflected or absorbed from the optical path) depends on the number of processing sites of the workpiece region located in the region of the master scanning region during a certain processing step. If, for example, it is possible in principle to split the laser beam into a 16x16 partial beam array and direct it towards a workpiece by means of the beam splitting unit, and if, however, only four processing sites or flaws are present in the region of the workpiece accessible to the master scanning region, only four partial beams have to be provided for processing. The surplus partial beams can then be deflected or removed (e.g. absorbed) from the optical path by the optical control unit or a beam selecting unit.

As was already mentioned, the optical control unit comprises a reflective optical functional unit. In this case, it is not excluded that the optical control unit or the reflective optical functional unit associated with the control unit in each case comprises several constituents or components. In the sense of the invention, a reflective optical functional unit is understood to mean that partial beams incident upon the reflective optical functional unit or constituents thereof are reflected or deflected. Preferably, the reflective optical functional unit is configured such that each partial beam hits a reflective component of the reflective optical functional unit, wherein the reflective component is a reflective beam direction manipulation unit. This will be explained in more detail later.

In the case of non-periodic or partially periodic processing patterns, it may also be necessary to individually position, within a predetermined partial beam scanning region, individual ones of the partial beams directed towards the workpiece and located within the master scanning region in accordance with the position of the processing site to be processed with the respective partial beam. Moreover, an individual movement (scanning movement) of the partial beams directed towards the workpiece can be carried out within the respective partial beam scanning region by means of the optical control unit.

As was already explained, the laser processing device may also (optionally) include a beam positioning unit, particularly in the form of a galvanometer scanner, a pivot scanner or a two-axis single mirror scanner, which is configured for carrying out a rough positioning process, relative to the workpiece, of the partial beams directed towards the workpiece, namely by positioning a master scanning region including the partial beam scanning regions relative to the workpiece. At the respective positions of the master scanning regions (and thus of the partial beams) set by means of the rough positioning process, an individual fine positioning process of the partial beams may be carried out within predetermined partial beam scanning regions of the respective partial beams, subsequent to the rough positioning process. A beam positioning unit configured as a galvanometer scanner may include one or more rotary drive unit(s) configured for moving mirrors provided in the beam positioning unit for the targeted deflection and positioning of the partial beams. Galvanometer scanners for use in laser processing device are generally known. All of the partial beams directed towards the workpiece are thus delivered by means of the beam positioning unit. Using a pivot scanner or a two-axis single mirror scanner, i.e. a beam deflection system permitting a virtual or real beam deflection in two directions in space from a point in space, may be advantageous if an F-sin-Theta lens or an F-sin-Theta objective is used, particularly for reducing distortion errors. A F-sin-Theta lens or F-sin-Theta objective is understood to be an objective with a rotationally symmetric correction or distortion in accordance with the function F-sin(theta).

Alternatively or additionally, the beam positioning unit is configured for moving, preferably synchronously and simultaneously, the partial beams directed towards the workpiece across the workpiece, namely by moving the master scanning region including the partial beam scanning regions relative to the workpiece.

The beam positioning unit is downstream of the optical control unit with respect to the beam direction or the beam path; thus, the beam path of the partial beams is configured such that the partial beams hit the beam positioning unit only after being reflected at the reflective optical control unit (or the respective reflective beam direction manipulation units). In particular, the beam positioning unit may be configured to image on the workpiece, in cooperation with the focusing unit, laser spots corresponding to the first number of partial beams. Moreover, the beam positioning unit may be configured to simultaneously and synchronously move the laser spots across the workpiece for positioning and/or processing. In this case, the positioning may precede the processing. The two steps may be repeated subsequent to the positioning of the workpiece relative to the laser processing device for the individual processing steps. However, it is also possible to process a workpiece at a predetermined number of sites without carrying out a processing movement, e.g. in the point-and-shoot mode. It may be expressly emphasized at this point that, though the partial beams directed towards the workpiece or the associated laser spots can be positioned and/or moved with the beam positioning unit, the beam positioning unit can only carry out a joint positioning or processing movement of all partial beams. In contrast, individual partial beams are individually positioned and/or moved within a predetermined partial beam scanning region independently of the beam positioning unit, i.e. by means of the optical control unit.

As was already mentioned, the beam positioning unit may be a galvanometer scanner, for instance. Such a galvanometer scanner may comprise one or more mirrors that can each be rotated by a defined angle about an axis of rotation. Thus, partial beams (or an associated master scanning region) reflected by the mirror can be directed to a desired site of the workpiece within an accessible scanning field. However, the use of a polygon scanner as a beam positioning unit may also be provided, particularly if an ultrashort pulse laser is used as a laser radiation source. Polygon scanners are particularly suitable for the high-resolution processing of a workpiece. Process times in workpiece processing can be significantly reduced with a scanner. Alternatively, however, a beam positioning unit configured for statically orienting the partial beams or associated laser spots towards the workpiece or position the partial beams or associated laser spots on the workpiece, may also be used.

As was already mentioned in the introduction, the invention is not only directed towards the laser processing device, but also towards a method for laser-processing a workpiece at predetermined processing sites, using the laser processing device according to the invention, however. To avoid repetitions, the features of the method according to the invention and advantageous embodiments of the method proposed with the invention are described already at this point. Of course, the features described in the context of the proposed method may also be used as advantageous embodiments of the laser processing device proposed with the invention. Thus, the laser processing device or constituents thereof may be adapted and/or configured for carrying out the process steps and/or features cited below.

According to the invention, a method is proposed for laser-processing a workpiece at predetermined processing sites using a laser processing device according to the invention, wherein, subsequent to the generation of a laser beam with a laser radiation source, beam splitting of the laser beam into a bundle of partial beams is carried out, and a predetermined number of partial beams of the bundle of partial beams is directed in an arbitrary spatial combination towards the workpiece at a predetermined number of sites using an optical control unit, and wherein the partial beams directed towards the workpiece are positioned and/or moved within a predetermined partial beam scanning region.

It should be emphasized that, within the framework of the terminology used in the present patent application, a positioning of partial beams directed towards the workpiece (irrespective of whether this is a rough or fine positioning process) is to be understood to be a positioning process carried out when the laser is turned off (laser radiation source); thus, no laser spot is imaged on the workpiece during the actual positioning. Only then is the laser radiation source turned on, and laser radiation (in the form of the partial beams directed towards the workpiece or of associated laser spots) is applied to the workpiece. That is, laser radiation (e.g. in the form of laser pulses) is applied only in a second step (subsequent to the positioning). Such a modulation can be carried out by means of a control unit or the laser radiation source.

According to an advantageous embodiment of the method according to the invention, a rough positioning process of the partial beams directed towards the workpiece at the predetermined number of sites can be carried out prior to the positioning of the partial beams in the respective partial beam scanning regions, particularly by arranging the workpiece in a workpiece holder and
a. positioning the workpiece relative to the laser processing device, or
b. positioning the partial beams, which are directed towards the workpiece and located within a master scanning region, relative to the workpiece using a beam positioning unit, or
c. positioning the workpiece relative to the laser processing device and the partial beams directed towards the workpiece and located within a master scanning region with a beam positioning unit.

The workpiece holder may be a constituent element of the laser processing device as such; moreover, the workpiece holder may be configured as a separate component. In the simplest case, the workpiece holder may be configured in the form of a support plate or a table on which the workpiece can be positioned in a gravity-based manner. Other configurations of the workpiece holder are also conceivable, as is providing suitable fastening or positioning means for fastening or positioning the workpiece in the workpiece holder. In addition, the workpiece holder may be an xy-table that can be moved in a horizontal plane. Accordingly, the workpiece can be moved by means of the xy-table in a horizontal plane or work plane.

According to the method, based on an input data set relating to the processing sites present on the workpiece, or the distribution thereof in space, a number of processing steps (which corresponds to the number of sites at which the partial beams directed towards the workpiece—particularly the partial beams located within the master scanning region - need to be positioned relative to the workpiece), a position of the workpiece relative to the laser processing device required for carrying out the respective processing steps, a processing path including the relative positions of the respective processing steps, and the number of partial beams required for the respective processing steps for processing the processing sites, the spatial arrangement of the partial beams or associated laser spots of a spot matrix, and the individual position of every partial beam in the predetermined partial beam scanning region can be determined and fixed. It must be noted in this case that there may frequently be a plurality of possible solutions (different processing paths, spot patterns at different processing sites, etc.). An efficient processing strategy taking into account the above-mentioned aspects can be determined by means of a suitable algorithm. Here, efficient means that a strategy is determined in which as many partial beams are positioned on the workpiece on average, in order thus to reduce the total processing time for the respective processing task. This can be carried out using a control unit (which may comprise a data processing unit), wherein the control unit may be a constituent element of the laser processing device or be an external control unit. In this case, the control unit is connected preferably in a controlling manner with the optical control unit. The control unit may comprise sub-control units that may be assigned to the respective constituents (e.g. the reflective optical control unit) of the laser processing device.

Subsequent to the positioning of the workpiece relative to the laser processing device and/or vice versa, the following steps may be carried out:
a. generating a laser beam from the laser radiation source and emitting the laser beam along an optical path in the direction of the workpiece;
b. selecting from the bundle of partial beams an arbitrary number of partial beams in an arbitrary spatial combination and directing the selected partial beams towards the workpiece, wherein this takes place using an optical control unit comprising a reflective optical functional unit;
c. positioning and/or moving, within a predetermined partial beam scanning region of the respective partial beam, each of the partial beams directed towards the workpiece.

It may be emphasized at this point that, according to the above-mentioned process step c., a desired number of partial beams directed towards the workpiece can be positioned and/or moved within the respective predetermined partial beam scanning region. Thus, it is not absolutely necessary to subject all of the partial beams directed towards the workpiece to a fine positioning process or scanning movement within the respective partial beam scanning region. A one-off positioning of a partial beam (through a rough positioning process by means of the beam positioning unit) may already be understood to be a positioning process in the sense of step c., but also a positioning of the partial beam in the partial beam scanning region carried out by means of the reflective optical functional unit.

Moreover, it may be advantageous within the framework of the method according to the invention if the control unit is configured for carrying out an individual scanning movement for at least one of the partial beams directed towards the workpiece subsequent to the rough positioning and the positioning within the predetermined partial beam scanning region of the partial beams directed towards the workpiece. Advantageously, such an individual scanning movement can be carried out by means of the control unit for any number of the partial beams directed towards the workpiece, e.g. for all partial beams or a predetermined number of partial beams. An “individual scanning movement” is to be understood to mean that a respective partial beam is moved across the workpiece along a predetermined trajectory within the partial beam scanning region, so that a predetermined contour is “traversed” or scanned, for example, which in the end results in a local processing of the workpiece.

According to another advantageous embodiment of the method proposed with the invention, it may be provided that, using the beam positioning unit, a simultaneous and synchronous scanning movement is carried out for the partial beams directed towards the workpiece, subsequent to the rough positioning and the positioning within the predetermined partial beam scanning region of the partial beams directed towards the workpiece. In this case, all of the partial beams directed towards the workpiece are each simultaneously and synchronously moved within the respective partial beam scanning region. A predetermined trajectory of the respective partial beams within the respective partial beam scanning regions can also be realized in this manner, so that a predetermined contour can be “traversed” or scanned within the partial beam scanning regions, for example, which in the end results in a local processing of the workpiece.

According to another advantageous embodiment proposed with the invention, it may be provided that, using the optical control unit and/or the beam positioning unit, a positioning correction of positioning errors, particularly resulting from distortion errors of an optical functional element, is carried out for a predetermined number of the partial beams directed towards the workpiece, subsequent to the rough positioning and, if necessary, the positioning within the predetermined partial beam scanning region of the partial beams directed towards the workpiece.

Thus, the optical control unit can be used for correcting optical positioning errors of the partial beams on the workpiece that may occur due to the distortion of an F-theta objective or otherwise corrected objectives. Thus, a correction of positioning errors can be carried out, in addition to the positioning of the respective partial beams on the workpiece (e.g. in order to carry out a laser drilling process) according to the method described herein or the laser processing device described herein. In the event that a 2×2 matrix of laser spots (partial beams) projected onto the workpiece, for example, is scanned (moved) with a beam positioning unit across the workpiece through an F-theta objective (an F-theta lens) or otherwise corrected objective, then the matrix of the laser spots (partial beams) may distort at certain scanning angles, particularly at scanning angles >(0,0) relative to the axis of symmetry of the objective. The matrix of the laser spots or partial beams then undergoes a rotation, and the distances of the laser spots change due to the optical distortion of the aforementioned F-theta objective and the present configuration of the beam positioning unit. With the method described herein or the laser processing device described herein, this effect can be actively compensated, for example, by the spot positions being adapted, through fine-positioning the laser spots or partial beams (by means of the control unit and/or the beam positioning unit), for each scanning angle set with the beam positioning unit (this may also be referred to as using a correction matrix), so that the positions of the matrix of the laser spots relative to the scanning angle setting with scanning angles of (0,0) are corrected. Thus, in order to optimally exploit a (relatively large) scanning field (master scanning region) of the beam positioning unit for parallel processing, the positional errors of the laser spots or partial beams need to be actively compensated. As is described above, this is made possible using the optical control unit, particularly the reflective optical functional unit (in particular using a correction matrix), and a beam positioning unit. A compensation of positioning errors can be attained individually for each partial beam depending on the scanning angle, given a fixed configuration of the beam positioning unit and the F-theta objective. The above-mentioned correction matrix can in this case be determined using an optical measuring system; the latter may preferably be a measuring system disposed in the focal point of a F-theta objective.

The above-mentioned correction matrix contains the required corrections of the fine-positioning system (of the reflective optical functional unit) for correcting positional errors of the partial beams induced by the beam positioning unit and an associated F-theta objective. In this case, the error is dependent on the scanning angle of the beam positioning unit.

Taking the above into account, it can be concluded that the partial beam scanning region of a partial beam directed towards the workpiece is composed of a scanning vector for correcting the above-mentioned positional error of the partial beam and a scanning vector for positioning the partial beam at the target position.

According to another advantageous embodiment of the method, it may be provided that, using the beam positioning unit, a simultaneous and synchronous scanning movement along a predetermined scanning track is carried out for the partial beams directed towards the workpiece subsequent to the rough positioning and the positioning within the predetermined partial beam scanning region of the partial beams directed towards the workpiece, wherein, when carrying out the scanning movement using the optical control unit, particularly the reflective microscanners, a dynamic positioning correction of positioning errors, particularly resulting from distortion errors of an optical functional element, is carried out for a predetermined number of the partial beams directed towards the workpiece, preferably using a correction matrix. When a scanning movement is carried out, the laser radiation source is turned on (in contrast thereto, the laser radiation source is turned off during a positioning process—be it a rough positioning or fine positioning process), so that the partial beams directed towards the workpiece can be moved across the latter accordingly. This permits scanning (carrying out the scanning movement) “long vectors” across the workpiece using the beam positioning unit, while simultaneously providing an option for correcting distortion errors more dynamically. Then, the partial beams directed towards the workpiece can be positioned within the respective partial beam scanning regions subsequent to the above-mentioned rough positioning process with the beam positioning unit. According to this embodiment, subsequent to such a positioning and a correction of static positioning errors of the partial beams possibly taking place (see the above description), a movement of the partial beams can be carried out along a scanning track, which may include the entire master scanning region, using the beam positioning unit, wherein the optical control unit dynamically compensates (real-time compensation) the positioning errors/distortion errors of the individual partial beams using the correction matrix.

This may be explained with the following example: A 1×4 matrix of partial beams or associated laser spots is arranged on the workpiece with the laser processing device. Then, 4 parallel lines are scanned across the workpiece. The length of the parallel lines corresponds to the length of the master scanning region. In the process, the beam positioning unit carries out the scanning movement, while the optical control unit, i.e. the respective microscanners, dynamically compensates the positional errors of the partial beams along the scanning track.

Advantageous embodiments of the laser processing device proposed with the invention are described in detail below, particularly this advantageous variants of the embodiments specified in the dependent claims. Here, the dependent claims relate to advantageous embodiments and developments of the present invention. The features mentioned in the dependent claims can be used in any combination for developing the laser processing device according to the invention and the method according to the invention to the extent this is technically possible. This also applies if such combinations are not expressly illustrated by corresponding references in the claims. In particular, this also applies across the boundaries of the categories of the patent claims. The features of the embodiments described in connection with the laser processing device according to the invention are equally also to be used as possible advantageous embodiments of the method according to the invention. For reasons of clarity, advantageous embodiments relating to the optionally provided beam positioning unit were already explained above. Nevertheless, the latter can also be combined with the additional ones of the technical embodiments described below or the features specified in the dependent claims.

According to a first embodiment of the invention, the laser processing device may include an optical functional unit disposed between the beam splitting unit and the reflective optical functional unit and comprising a group of optical functional elements disposed one behind the other. In particular, it may be provided that the group of optical functional elements disposed one behind the other comprises:
a. a focusing unit formed, in particular, of one or several lenses, lens systems, mirrors disposed one behind the other, or a combination thereof,
b. a lens array of lenses spaced apart from the focusing unit.

In this case, in a two-dimensional lens array, for example, one more “line” or “column” of lenses is always required than in the array of microscanners of the reflective optical functional unit. For example, if an assembly of 4 x 4 microscanners is provided, an assembly of 5×4 or 4×5 lenses would be required in the lens array.

In particular, the number of lenses of the lens array is dependent on the number of lenses required to ensure that the partial beams, on the second beam track (subsequent to the reflection on the reflective optical functional unit), can in each case pass through a lens which, compared to the first beam track (i.e. the beam track of the partial beams prior to hitting the reflective optical functional unit), is directly or not directly adjacent.

In the sense of the invention, the optical functional unit can be understood to be an optical functional unit whose constituent elements (the focusing unit and the lens array) can be penetrated by the partial beams, i.e. are configured to be transmissive. However, this does not preclude individual elements of the optical functional unit from being configured to be reflective.

According to another advantageous embodiment of the invention, a laser processing device configured in such a manner may be provided, in which the partial beams belonging to the bundle of partial beams pass through the optical functional unit, in particular the focusing unit and the lens array, on a first beam track until being reflected at the reflective optical functional unit and, subsequent to being reflected at the reflective optical functional unit, at least a part of the partial beams reflected there again pass, on a second beam track, through the optical functional unit, in particular the lens array and the focusing unit. The partial beams may be optically refracted when passing through the focusing unit and the lens array. Subsequent to the beam splitting process in the beam splitting unit, the partial beams accordingly propagate as a bundle of collimated partial beams in the direction of the focusing unit.

Preferably, the laser processing device may further be configured in such a manner that each partial beam of the bundle of partial beams passes on the first beam track through a lens of the lens array assigned to the respective partial beam, and at least a part of the partial beams reflected at the reflective optical functional unit passes on the second beam track through a lens of the lens array assigned to the respective partial beam. On the second beam track—as will be explained later on—a respective partial beam passes through a, compared with the first beam track, different lens, particularly an adjacent one. Thus, an “assignment” in this connection is not to be understood to mean that a partial beam passes through one and the same lens on the first beam track and the second beam track.

In this case, it may be provided that each partial beam of the bundle of partial beams passes on the first beam track through the focusing unit , and, on the second beam track, at least a part of the partial beams reflected at the reflective optical functional unit passes again through the focusing unit.

In this case, it may be provided that not all of the partial beams passing through the focusing unit and the lens array on the first beam track end up in the direction of the workpiece, but are previously (preferably on the second beam track) deflected or removed from the beam path by suitable means. Accordingly, it may be provided that a predetermined number of partial beams, preferably on the second beam track, are deflected or absorbed from the optical path so that the deflected partial beams do not hit the workpiece. This may be effected either by means of a beam selecting unit provided specifically for this purpose, or by a reflective optical functional unit. In accordance with the number of partial beams required for processing at a given position of the master scanning region on the workpiece, the corresponding number of non-required partial beams can thus be deflected or removed from the beam path of the partial beams.

The focusing unit may be configured, for example, as a single lens, e.g. as an asphere. In practical application, however, the use of complex lens systems has proved advantageous because aberrations can be better corrected with them.

According to an advantageous embodiment of the invention, it may be provided that the bundle of the plurality of partial beams, prior and subsequent to passing through the focusing unit on the first beam track, has a partial beam bundle axis, in relation to which the plurality of partial beams is preferably disposed symmetrically. Moreover, it may be advantageous if the partial beam bundle axis is preferably normal to a microscanner plane in which the reflective microscanners are arranged. A certain geometrical basic arrangement of the partial beams imaged on the workpiece is predetermined by such beam splitting, wherein the laser processing device according to the invention makes it possible to individually position each of the partial beams within a predetermined partial beam scanning region. By the partial beams passing through the focusing unit, the partial beams are parallelized relative to one another and focused.

According to another advantageous embodiment of the present invention, it may be provided that the focusing unit is arranged in such a manner that the partial beam bundle axis, prior to the partial beams hitting the focusing unit on the first beam track, is offset relative to an axis of symmetry of the focusing unit extending along the optical path. An offset is to be understood to be, in particular, a parallel offset by a predetermined distance. Here, parallel offset means that the partial beam bundle axis is offset parallel to the axis of symmetry of the focusing unit. The offset of the bundle of partial beams or of the partial beam bundle axis relative to the axis of symmetry of the focusing unit causes the partial beam bundle axis, subsequent to the partial beams passing through the focusing unit on the first beam track, to extend at an angle to the axis of symmetry of the focusing unit.

According to another advantageous embodiment of the present invention, it may be provided that the focusing unit is arranged in such a manner (the crucial point is, in particular, the arrangement relative to the beam splitting unit) that the bundle of partial beams, prior and/or subsequent to passing through the focusing unit on the first beam track, has a telecentric beam path. This applies particularly after the partial beams pass through the focusing unit on the first beam track. The telecentric property of the focusing unit causes the bundle of partial beams, subsequent to passing through the focusing unit, to first propagate along the first beam track in such a way that the optical axes of each partial beam are parallel to one another. This means the following: The respective partial beams of the bundle of partial beams each have a bundle of a predetermined number of sub-partial beams (the sub-partial beams are focused on the workpiece). Here, a telecentric beam path is understood to mean that these sub-partial beams can each be described by a main beam (the partial beam), wherein the main beams are parallel to one another after passing through the focusing unit. In particular, the main beams are orientated parallel to an axis tilted with respect to the axis of symmetry of the focusing unit. The tilting of the axis results from the offset of the partial beam bundle axis with respect to the axis of symmetry of the focusing unit prior to passing through the focusing unit on the first beam track.

On the second beam track, i.e. on the beam track following the reflection of the partial beams at the reflective optical functional unit, the beam path or the beam trajectory of the partial beams may at least in some section be telecentric or non-telecentric. In the case of a telecentric beam track or beam trajectory, the reflective optical functional unit is arranged such that the optical axes of the partial beams on the second beam track, for the scanning angle set with reflective optical functional unit, particularly the associated microscanners, result in the partial beams in each case being parallel to one another again after passing through the lens array again. Thus, the maximum scanning region that can be set with the microscanners is necessarily limited to a region smaller than the diameter of the lens associated with the lens array. With respect to the partial beams, this means for the scanning function fulfilled with the reflective optical functional unit that the respective scanning field of a partial beam is smaller or considerably smaller than the distance between the partial beams of the workpiece. Thus, the filling degree of the scanning field or master scanning region on the workpiece is limited. In the case of a non-telecentric beam track or beam trajectory, the arrangement of the microscanners (or of the reflective optical functional unit) and the lens array is chosen such that the optical axes of the partial beams on the second beam track, after passing through the lens array, are not parallel, i.e. the optical axes describe a certain angle space. This leads to the scanning region that can be set with the microscanner being larger, or possibly being larger, than the diameter of the respective lenses of the lens array. The scanning region of each partial beam can thus be enlarged; the filling degree of the scanning region on the workpiece becomes larger; at most, even a complete covering of the scanning region with partial beams can be attained. However, a non-telecentric beam path behind the lens array results in an offset of the partial beams in the entrance pupil of a focusing objective of the beam positioning unit when scanning with the partial beams with the microscanners. On the workpiece, this results in partial beams that hit the workpiece not perpendicularly, but at an angle of <90°, which may be disadvantageous for some applications, but tolerable for other applications. In particular, however, the angle is dependent on the positioning of the focusing optics unit relative to the entrance pupil of the focusing objective of the beam positioning unit. Here, the crucial point is that the change of the position of the partial beam in the entrance pupil of the objective results in a change of the angle of incidence of the partial beam on the workpiece.

As was already mentioned, it may be provided, in accordance with another advantageous embodiment of the present invention, that the optical partial beam bundle axis, subsequent to the partial beams passing through the focusing unit on the first beam track, extends at an angle to the axis of symmetry of the focusing unit. This is a consequence of the focusing unit having a focal length other than zero and the partial beam bundle axis being offset to the axis of symmetry of the focusing unit.

According to another advantageous embodiment of the present invention, it may be provided that the partial beams of the bundle of partial beams are focused on the first beam track in a plane disposed perpendicular to the optical path or to the axis of symmetry of the focusing unit, wherein the plane is preferably disposed between the focusing unit and the lens array. The partial beams may also readily be focused in a virtual focal plane. Also on the second beam track, it may be advantageous to focus the partial beams of the bundle of partial beams in the above-mentioned plane after they have passed through the lens array.

According to another advantageous embodiment of the invention, it may be provided that the lens array comprises a lateral assembly of lenses or lens systems (e.g. doublet lenses or triplet lenses), which are preferably disposed in a common lens plane, wherein the lens plane is disposed perpendicular to the optical path or to the axis of symmetry of the focusing unit. The lenses or lens systems associated with the lens array are preferably identical lenses or identical lens systems. In this case, the lenses or lens systems may be arranged, in particular in the form of a grating assembly or hexagonal arrangement, in the lens plane. As was already mentioned, the lenses of the lens array are in this case arranged in such a way that each partial beam of the bundle of partial beams passes through one lens in each case. In this case, a partial beam passes one lens on the first beam track, and passes through another lens (preferably an adjacent lens) on the second beam track. However, it is essential that each partial beam on the forward journey respectively passes through a different (its own) lens; i.e., no lens is traversed by two partial beams on the forward journey. On the return journey, each partial beam also passes through a different (its own) lens, which is not identical to the lens that it has passed through on the forward journey, but preferably is an adjacent lens.

Such an assembly permits a separation of the partial beams into separate optical channels. Each partial beam passing through the lens array or the individual lenses is collimated on the first beam track by the respective lens of the lens array. The distance between the focusing unit and the lens array is selected such that the partial beams are substantially collimated after passing through the lens array. After the partial beams have passed through the lens array, the partial beams propagate in the respective optical channels on the first beam track until they hit the reflective optical functional unit.

As was already mentioned, it is provided according to the invention that the reflective optical functional unit is formed from an array of reflective microscanners. The array of reflective microscanners may (but does not have to) comprise a lateral assembly of reflective microscanners, which are preferably disposed in a common microscanner plane, wherein the microscanner plane is disposed perpendicular to the optical path or to the axis of symmetry of the focusing unit. In this case, the reflective microscanners are arranged in such a way that one partial beam is in each case reflected by one microscanner. The angle of incidence of each partial beam on the respective reflective microscanner in this case approximately corresponds to the above-mentioned angle between the partial beam bundle axis and the axis of symmetry of the focusing unit. Accordingly, the number of the reflective microscanners corresponds to the number of partial beams extending along the first beam track. After a respective partial beam has hit a reflective microscanner, the partial beam is reflected on this microscanner.

Preferably, each microscanner is configured to assume a basic position and at least one first deflecting position, wherein a microscanner located in the first deflecting position is configured for deflecting a partial beam hitting the microscanner in the direction of the second beam track. It may further be provided that each microscanner is configured to assume a second deflecting position, wherein a microscanner located in the second deflecting position is configured for deflecting from the optical path a partial beam hitting the microscanner. If it is provided that the respective microscanners are able to assume two deflecting positions, it may be advantageous if the respective partial beams are deflected, in the first and second deflecting positions of the respective microscanners, along a first and a second direction in space, wherein the first and second directions in space extend perpendicularly to the axis of symmetry of the focusing unit.

Furthermore, it may be provided that, for the respective partial beam hitting the microscanner, an angle of deflection can be adjusted with the respective microscanners in a flexible and dynamic manner. A dynamic adjustment is understood to mean that each microscanner is able to draw upon its own scanning program which, for example, comprises a plurality of micro-vectors (relating to the orientation of the microscanner). In this case, the microscanners may be adjusted, in particular, electromechanically, wherein the deflection angles are adjusted, in particular, by means of a control unit connected to the array of microscanners or the individual microscanners.

Using the microscanners, an additional angular deflection may be added to each partial beam which, after the partial beams have passed through the lens array on the second beam track, results in an offset of the respective focal point of the partial beams in the above-mentioned plane (what is meant is the common focal plane between the lens array and the focusing unit). Consequently, the angular deflection induced with the microscanners has an effect on the position of the partial beams directed towards the workpiece. Accordingly, they may be positioned and/or moved within a predetermined partial beam scanning region.

According to another embodiment, it may be provided that the lens plane of the lens array has the same inclination as the microscanner plane of the array of reflective microscanners, and that the lenses or lens systems are disposed with the same arrangement symmetry, e.g. in a Cartesian arrangement, as the microscanners in the microscanner plane.

As was already mentioned, the respective collimated partial beams propagate along the second beam track back to the lens array subsequent to being reflected at the microscanners. Depending on the angular deflection at the reflective microscanner array, the respective partial beams now have an additional angular deflection compared with a partial beam reflected on a microscanner in the basic position. The bundle of collimated partial beams again hits the lens array. In the process, a substantially collimated partial beam passes through exactly one lens or lens system of the lens array. Conversely, each lens or each lens system of the lens array is penetrated by exactly one partial beam of the bundle of partial beams reflected on the microscanner array. On the first beam track (i.e. the beam track from the focusing lens to the lens array) and the second beam track (i.e. the beam track from the microscanner array to the lens array), a partial beam thus penetrates the lens array twice with a different, in particular opposite, propagating direction.

As was already mentioned, it may be advantageous in the context of the invention that the partial beams reflected at the microscanners pass through the lens array again on the second beam track, wherein a respective partial beam, on the second beam track, passes through a lens of the lens array which is disposed adjacent to a lens of the lens array through which the partial beam passes on the first beam track. Thus, the partial beams on the first beam track (which may also be referred to as the forward journey of the partial beams towards the reflective optical functional unit) pass through a different lens of the lens array than on the second beam track (which may also be referred to as the return journey of the partial beams back from the reflective optical functional unit). Preferably, the lenses though which a single partial beam passes on the first and the second beam track are adjacently disposed. Only due to this fact is a separation of the channels into different directions in space on the forward and return journeys made possible by the microscanners, given an otherwise telecentric arrangement. In this context, “adjacent” may be understood to mean a directly adjacent (lenses are arranged, for example, next to each other or one above the other) arrangement of the lenses, but also a non-directly adjacent arrangement (i.e. the lenses are not directly next to each other , one above the other, etc.).

According to another advantageous embodiment of the invention, it may be provided that the microscanners are micromirrors or MEMS mirrors/MEMS scanners, wherein each microscanner is configured for deflecting in two coordinate directions a partial beam hitting it. A coordinate direction may be understood to be a direction (e.g. a vertical or horizontal one) in a plane spanned in space. In the case of a microscanner array, this is a DMD assembly. As is known, the acronym MEMS stands for micro-electro-mechanical systems. The acronym DMD denotes a “digital micromirror device”. Both components are known from the prior art, which is why reference is made at this point to general expert knowledge. MEMS mirrors consist of a single mirror substrate and can be operated either in a resonant or quasi-static manner. Such mirrors are two-dimensional elements for beam deflection. Possible scanning frequencies range from 0.1 kHz to 50 kHz. The microscanners (micromirrors or MEMS mirrors) arranged in the microscanner array can be individually controlled and tilted or moved by means of the control unit in order to be able to individually deflect each partial beam or provide it with an additional angle of deflection.

According to another advantageous embodiment, it may be provided that the microscanners are at least partially provided with a dielectric coating. Compared with a metallic surface, a dielectric coating prevents the microscanner from heating up due to a residual absorption of the laser radiation hitting the microscanner. It may be provided that each microscanner be dielectrically coated in its entirety, or only partially.

According to another advantageous embodiment, it may be provided that the partial beams again pass through the focusing unit as a bundle of partial beams on the second beam track, wherein the partial beam bundle axis, prior to the partial beams hitting the focusing unit on the second beam track, is offset and/or tilted relative to the axis of symmetry of the focusing unit extending along the optical path.

According to another advantageous embodiment, a beam selecting unit may be provided, in particular in the form of an array of aperture diaphragms, which is configured for diverting, e.g. reflecting, or absorbing a predetermined number of partial beams, preferably on the second beam track, from the optical path, so that the deflected partial beams do not hit the workpiece, wherein the beam selecting unit, with respect to the beam path, is preferably disposed downstream of the reflective optical functional unit. At the same time, the aperture diaphragm may also be disposed between the microscanner array and the lens array. If the beam selecting unit is configured in the form of an array of aperture diaphragms, the array of aperture diaphragms is designed in such a way that a partial beam, for a certain deflection angle of the partial beam set by means of a microscanner, hits the aperture diaphragm and is absorbed by the latter, or is reflected into a beam dump. For other deflection angles, the partial beam propagates through the aperture diaphragm unimpededly.

The number of the partial beams hitting the workpiece can be flexibly adjusted via the cooperation of the reflective optical functional unit and the beam selecting unit. This relates not only to the number of partial beams, but also to their selection in space, with respect to a two-dimensional partial beam bundle provided by the beam splitting unit. From the bundle, the partial beams can be selected in any combination as regards their position and assigned to the above-mentioned first or second numbers of partial beams.

According to another advantageous embodiment of the invention, it may be provided that the beam selecting unit is configured to be reflective, in particular as a micromirror or as a MEMS mirror. In this case, individual partial beams can be deflected in the direction of the respectively configured beam selecting unit by the respective microscanners. Moreover, the beam selecting unit may be configured such that it comprises a fixed array of mirrors or micromirrors that guide a predetermined number of partial beams (also a certain partial beam) into a beam dump. At the same time, the microscanner array or each microscanner may also act as a beam selecting unit (by deflecting partial beams from the optical path in the direction of a secondary path). The beam selecting unit may also comprise an array of micromirrors or MEMS mirrors. The mirrors arranged in the beam selecting unit can be individually controlled and tilted or moved by means of a control unit in order to be able to individually deflect each partial beam. As was already mentioned, a first number of partial beams can be transferred or deflected along the optical path in the direction of the workpiece, or removed or deflected from the optical path (the partial beams deflected from the optical path do not hit the workpiece).

According to another advantageous embodiment, it may be provided that the mirrors disposed in the beam selecting unit are at least partially provided with a dielectric coating. Compared with a metallic surface, a dielectric coating prevents the mirror from heating up due to a residual absorption of the laser radiation hitting the mirror. It may be provided that each mirror be dielectrically coated in its entirety, or only partially.

As was already described above, the beam selecting unit may also be configured to be transmissive or absorptive in an alternative configuration, in particular as a blocking member disposed on a chip. However, such chips are freely available on the market (see, for example, https://www.preciseley.com/mems-optical-shutter.html). In this case, the above-mentioned blocking member can be moved at least from a first into a second position within a chip plane. A transmission (i.e. a penetration) of a partial beam hitting the blocking member is made possible in the first position. In contrast, a penetration of a partial beam hitting the blocking member is prevented in the second position (absorption). The switching over of the blocking member may be controlled by means of the control unit; accordingly, such a chip (or an array of such chips) is also suitable for use with the present invention. Such a blocking unit may be provided for one or more partial beams, and may be disposed between the focusing unit and the lens array, or between the lens array and the microscanner array.

According to another advantageous embodiment of the invention, it may be provided that, between the laser radiation source and the beam splitting unit, a beam shaping element is disposed which is configured for converting a Gaussian intensity distribution of the laser beam into a deviating intensity distribution, in particular into a top-hat intensity distribution or ring-shaped intensity distribution.

According to another advantageous embodiment of the invention, it may be provided that the beam splitting unit is configured for splitting the laser beam into a bundle of partial beams, wherein the partial beams preferably (in the angle space) have equidistant distances from each other. The partial beams may also be split into a hexagonal bundle by the beam splitting unit; thus, the partial beams are arranged in a hexagonal distribution in a cross section. An offset of the partial beams provided in this manner can be changed by adding an angular deflection by the reflective optical control unit, particularly by the microscanner array. The angular deflection, which is adjustable for each partial beam by means of the respective microscanner (in particular MEMS mirror), results in an additional beam offset of a respectively manipulated partial beam on the workpiece, i.e. to a positional shift within the respective partial beam scanning region.

According to another advantageous embodiment of the invention, a control unit may be provided which is configured for determining, based on predetermined data, a processing path for roughly positioning the partial beams directed towards the workpiece by positioning the master scanning region at different sites of the workpiece, wherein the control unit is connected to the beam positioning unit in a controlling manner.

According to another advantageous embodiment of the invention, it may be provided that the control unit is also connected in a controlling manner to the optical control unit, in particular to the microscanner array, and to the beam selecting unit.

According to another advantageous embodiment of the invention, it may be provided that the control unit is configured, for each of the different sites of the master scanning region on the workpiece,
a. to determine a first number and arrangement in space of the partial beams directed towards the workpiece;
b. to determine a second number and arrangement in space of the partial beams to be diverted or to be absorbed from the optical path;
c. to cause the diversion or absorption of the number and arrangement in space of partial beams determined in accordance with step b.;
d. to determine, for each of the partial beams to be directed towards the workpiece, a position within the predetermined partial beam scanning region of the respective partial beam and set it by means of a corresponding deflection of the micro scanner of the microscanner array assigned to the respective partial beam, and/or to determine, for a predetermined number of partial beams, a scanning path and execute a scanning movement of the respective partial beams by controlling the microscanners assigned to the respective partial beams.

The conditions described under the above items a. and b. define the design of a two-dimensional spot array required for processing at a certain position. The number of the partial beams directed towards the workpiece or of the laser spots imaged thereon, as well as the arrangement or distribution of the laser spots in space depends, in particular, on the number of processing sites on the workpiece or their two-dimensional distribution in space. For this purpose, the control unit may be configured for controlling the optical control unit and/or the beam selecting unit. Only in this manner can the laser processing device be operated in accordance with the conditions described under a. to c. For example, using the control unit, a partial beam can be caused to be deflected in the direction of a beam selecting unit by means of a microscanner associated with the optical control unit, particularly the adjustment of a position of the microscanner. At the same time, the beam selecting unit can also be controlled by the control unit such that a partial beam is deflected, absorbed or otherwise removed from the beam path, e.g. by inserting a diaphragm or beam dump into the beam path of a partial beam reflected on the reflective optical functional unit.

According to another advantageous embodiment of the invention, it may be provided that the control unit is configured for controlling the beam splitting unit, the reflective optical functional unit and the beam positioning unit. Depending on the processing task and the required number of partial beams to be directed towards the workpiece at a certain site thereof, the beam splitting unit, the reflective optical functional unit, in particular each individual microscanner, and the beam positioning unit are controlled accordingly by means of the control unit. Alternatively or additionally, the control unit is also capable of positioning and/or moving a positioning unit (e.g. an xy-table) connected to the workpiece holder.

According to another embodiment of the invention, a focusing optics unit may be provided, which is disposed downstream of the beam positioning unit with respect to the second beam track, and which is configured for focusing the partial beams (directed towards the workpiece) on the workpiece while forming laser spots. For example, the focusing optics unit may be configured as a lens, preferably as a F-theta lens, which is also referred to as a flat field lens. An F-sin(theta)-corrected lens may be used as a focusing optics unit. In this case, a lens is also to be understood in this connection to be a complex lens system composed of several lenses. Moreover, the laser processing device according to the invention is suitable for compensating possible distortion errors of the F-theta lens by positioning the partial beams accordingly.

The laser processing device proposed with the invention may have a laser radiation source with which a pulsed laser beam can be generated. In this case, typical pulse repetition rates are in the range of a few hertz to a few megahertz. For high-quality material processing, it has proved advantageous if the pulse duration is less than 100 ns, preferably less than 10 ns, in particular less than 1 ns. In this pulse duration range, thermally caused effects dominate in material processing. In this case, the pulses can be applied at average powers of more than 10 W, even more than 40 W. Depending on the application, average powers of a few 50-500 mW, but also average powers of 10-50 W, may be provided for each partial beam.

If pulsed laser radiation with a shorter pulse duration is used, effects gain influence that are accompanied by the deposition of comparably very high energy quantities in a very short time, i.e. high peak powers. These effects may be, in particular, sublimation effects in which the material of the workpiece abruptly evaporates locally, i.e. such effects in which a material removal takes place instead of a shift of material. Here, the use of pulsed laser radiation with a pulse duration of less than 100 ps, in particular of less than 10 ps, and very particularly preferably of less than 1 ps has proved advantageous. In particular, pulse durations in the range of a few femtoseconds up to about 10 ps permit a targeted material removal by sublimation. Typical pulse repetition rates are between 50 and 2000 Hz. The pulse energies used within the context of the present invention may be in the range of 5 to 5000 μJ for the laser beam prior to beam splitting.

Laser radiation sources with even shorter pulse durations that will be available in the future can also be used, advantageously, in connection with the laser processing device according to the invention or the method according to the invention.

However, the use of pulsed laser radiation with even longer pulse durations than the above-mentioned 100 ns may also make sense, particularly if certain wavelengths are required for the processing task, or if a slower energy deposition is advantageous, e.g. in order to achieve a targeted local heating effect for initiating a local processing reaction, which may also be of a chemical nature, such as triggering a polymerization reaction, and at the same time prevent premature material removal.

Though the present invention is not limited to the use of a laser with a certain wavelength, in processes of repairing flaws, however, the use of a UV laser as a laser radiation source is advantageous in which the laser radiation source preferably generates a laser beam with a wavelength of 355 nm, 343 nm, 266 nm or 257 nm. When ablation-processing a workpiece with a laser processing device according to the invention, the wavelength may be selected such that the laser radiation is absorbed by the material to be ablated. Laser radiation with wavelengths in the near infrared and VIS ranges is not very suitable for repair processes, unless short pulse durations in the picosecond and femtosecond ranges are used. Preferably, the laser radiation source is configured for generating monochromatic laser radiation. However, depending on the processing task, broadband laser radiation sources may be advantageous. The use of IR lasers (in particular 1030 nm, 1064 nm) and VIS lasers (515 nm, 532 nm) is advantageous for the application of the laser processing device or of the method in laser drilling, which is also included in the present invention.

According to another embodiment of the present invention, a mask, which is configured for filtering out partial beams of higher or unwanted orders, may be disposed between the beam splitting unit and the focusing unit. The mask may also be provided and configured for filtering out non-refracted portions of the laser radiation.

According to another advantageous embodiment of the laser processing device according to the invention, the laser processing device may comprise a quarter-wave retardation element. This retardation element permits the adjustment of the direction of polarization of the generated laser radiation, e.g. from linear polarization to circular polarization.

By means of the laser processing device according to the invention, or the method according to the invention, an array of processing points (foci), which have an identical z-focal position, can be formed on a workpiece to be processed by means of the partial beams directed towards the workpiece. The positions of the individual processing points (partial beams or associated laser spots) from the array of the processing points in this case have a basic order predetermined by the angular distribution of the beam splitting unit. Due to the possibility of individually deflecting each partial beam by means of the array of microscanners, each processing point can be moved or positioned across the workpiece in a certain region (the partial beam scanning region). In this case (due to the telecentric beam guidance), the partial beam scanning region of each partial beam is, as a matter of principle, always smaller than the distance between two processing points. In contrast, the partial beam scanning regions can overlap on the workpiece in the case of a non-telecentric beam guidance. Moreover, a certain processing point can be completely hidden by deflecting a partial beam into the beam selecting unit. This results in a flexible arrangement of laser spots on the workpiece.

According to another embodiment of the invention, it may be provided that those of the components associated with the laser processing device, in particular the beam splitting unit, the focusing unit, the lens array and the microscanner array, are arranged or configured such, with respect to their spacing and focal lengths, that a beam splitting plane provided in the beam splitting unit is imaged onto the individual microscanners and the microscanner plane is further imaged in a common plane, wherein individual optical channels assigned to the partial beams - even if an individually set partial beam direction is changed - cross in a crossing point in the plane.

According to another embodiment of the laser processing device proposed with the invention, it may be provided that the beam positioning unit and/or the focusing optics unit is/are disposed in such a way that the entrance pupil of the focusing optics unit is disposed in the crossing point or a crossing region of the partial beams. The location at which the partial beams (ideally) converge (crossing point) is the ideal location for selecting the entrance pupil of the focusing optics unit, in particular of the F-theta objective. Instead of a defined crossing point, however, the partial beams may also extend across a crossing region extending in space.

In another alternative of the invention, it may be advantageous if the optical functional unit has a staircase mirror, which is provided instead of or in combination with the focusing unit, wherein the staircase mirror is configured for generating a focal plane tilted relative to the propagation direction of the partial beams. With a staircase mirror in the convergent (or divergent) beam path, a bundle of partial beams can be deflected in such a way that the plane of foci is at an angle to the (parallel) propagation direction. Thus, the function of the focusing unit with an offset bundle can also be achieved by means of a staircase mirror. The distance between the individual foci of the partial beams can in this case be adapted without increasing the spectral errors of the partial beams. In this case, the structure of the staircase mirror is designed such that the individual mirror facets are located parallel to one another, but not in a single plane. Also for the case of a telecentric bundle of partial beams, this permits focusing the bundles in a plane that has an angle to the propagation direction of the bundles deviating from the perpendicular. A two-dimensional arrangement of laser partial beams requires for each partial beam two deflections, which are angled relative to each other, by the facets of a staircase mirror.

The above-described laser processing device, or the associated method, serve the purpose, among other things, of imaging a number of laser partial beams or the associated laser spots (in other words, an array of laser foci) on a workpiece and of individually positioning and/or moving these laser spots. In such a laser processing device, beam splitting can take place using a beam splitting unit (e.g. a DOE). Foci of the partial beams are generated in a (possibly virtual) intermediate plane by means of a focusing unit (focusing optics unit). As was explained in detail above, the bundles of partial beams are collimated on the first beam track on an array of microscanners by means of a lens array. On the second beam track, the partial beam bundles deflected there are in turn focused by the lens array (under a different angle, however) and collimated by the focusing optics unit.

The above-described laser processing device is characterized in that the microscanners are arranged as an array of microscanners arranged side-by-side, and the (lateral) distance of the microscanners from one another corresponds to both the (lateral) lens distance of the lens array and the distance of the focal points in the above-mentioned intermediate plane. On the one hand, such an arrangement permits the telecentricity to be preserved during the scanning of the individual laser spots, on the other hand, the number of the microscanners can be easily adapted by expanding the array.

If such microscanners are used (e.g. for technological reasons) in the form of individual scanners (scanning of a partial beam) that require large distances from one another, the necessary fixed ratio of the lateral distances of the lens array, the array of the microscanners and the intermediate foci constitutes a considerable disadvantage or limitation. Because the large distances between the foci in the intermediate plane require a long focal length of the focusing optics unit if small angular distances of the partial beam bundles at the beam positioning unit are to be achieved at the same time. The smaller the laser spot array on the workpiece to be processed is supposed to become, the longer the focal lengths of the focusing must be selected. Accordingly, the total length of the system and the size of the laser processing device increases. In practical application, this results in considerable limitations with regard to the use of conventional microscanners, which require distances of a few centimeters because of their size.

In order to work around this limitation, it is possible to deviate from arranging the microscanners in the form of an array of microscanners disposed in a plane parallel to the lens array. This is done by carrying out an additional deflection of the partial beam bundles between the lens array and the microscanners. The microscanners may then be disposed at different positions in space. In principle, it may be emphasized at this point that the term “array” in the sense of the present invention is not only to be understood to be a uniform arrangement of a plurality of microscanners in a plane, but also a different “arrangement” of the microscanners in three-dimensional space or in a plane.

According to an advantageous embodiment of the invention, the deflection can be provided by a mirror device being disposed between the lens array and the microscanners, which is disposed and configured such that the partial beams passing through the lens array on the first beam track are respectively directed in the direction of one of the microscanners, and the partial beams reflected at the microscanners are each directed in the direction of the lens array on the second beam track. With respect to the optical path, the partial beams may be directed radially outward, for example, whereby the laser processing device can be given a more compact configuration. Using such a mirror device, a plurality of different beam deflections and arrangements of the microscanners can be made possible, depending on the structure, size, number of mirror surfaces or mirrors of the mirror device.

According to another embodiment of the invention, the mirror device may have a plurality of mirror surfaces, wherein each mirror surface is configured so as to deflect a partial beam passing through the lens array on the first beam track in the direction of one of the microscanners, and to deflect a partial beam reflected at one of the microscanners in the direction of the lens array on the second beam track. In particular, the mirror device may be a pyramid mirror (other shapes are also possible). If the laser processing device comprises an assembly of 2×2 microscanners, for example, i.e. a total of four microscanners, then a pyramid mirror with four mirror surfaces may be used as a mirror device, for example, in order to direct, by means of each one of the four mirror surfaces, in each case one of four partial beams generated by means of beam splitting towards one of the four microscanners in each case, and direct it back in the direction of the lens array after the reflection of the partial beam. Such an arrangement makes it possible to dispose the microscanners in different planes, wherein the planes are each situated at an angle, preferably perpendicularly, to the lens plane. Thus, construction space is saved and the laser processing device can be given a more compact configuration. By means of such a deflection of the partial beams, the clear distance between the microscanner in relation to the lens array and the distances of the intermediate foci can be increased, so that the laser processing device can be made more compact as a whole, and more construction space is available for arranging the microscanners.

Moreover, in microscanner assemblies with more than 2×2 microscanners, the deflection may take place in different planes along the beam propagation, so that the arrangement positions of the microscanners (compared with the arrangement in a common plane) can also be separated.

With respect to the present invention, it may be provided for this purpose that the mirror device comprises a plurality of mirrors, wherein a first number of the mirrors is disposed in a first mirror plane and a second number of the mirrors in a second mirror plane, wherein the mirror planes are disposed preferably perpendicularly to the optical path or to the axis of symmetry and spaced apart from each other.

In this case, the mirrors disposed in the mirror planes may be disposed at an angle to the mirror planes. Depending on the structural situation of the laser processing device and the number of microscanners, the individual mirrors may take on different angles or orientations. In this case, each mirror is configured so as to direct a partial beam passing through the lens array on the first beam track in the direction of one of the microscanners, and to direct a partial beam reflected at one of the microscanners in the direction of the lens array on the second beam track.

Moreover, it is conceivable to use two-axis single mirror scanners as microscanners instead of micromirrors or MEMS mirrors/MEMS scanners, wherein the single mirror scanners are preferably motor-driven. A two-axis single mirror scanner is to be understood to be a scanning system which comprises a mirror that can be dynamically tilted about two axes that are preferably perpendicular to each other. The movability of the single mirror scanners may be piezo-based, galvanometer-based or servomotor-driven.

Moreover, it is conceivable to use galvanometer scanners as microscanners instead of micromirrors or MEMS mirrors/MEMS scanners. According to the invention, the microscanners may thus be galvanometer scanners, wherein each galvanometer scanner comprises two mirror elements with separate scanner axes, and wherein each microscanner is configured for deflecting in two coordinate directions a partial beam hitting it. A perfect telecentricity cannot be achieved by separating the scanner axes to two mirror elements. However, even in the case of today's single-beam scanner systems, this small deviation does not constitute a great limitation.

All of the above-described embodiments of the laser processing device may also be used in a method according to the invention or provide advantageous embodiments of the same.

Other advantages, configurations and developments in connection with the laser processing device according to the invention or the method according to the invention are explained in more detail with reference to an exemplary embodiment described below. This is supposed to illustrate the invention to the person skilled in the art and make it possible for him to carry out the invention, without, however, limiting the invention. The features described with reference to the exemplary embodiment may also be used for developing the laser processing device according to the invention and the method according to the invention. The exemplary embodiment is explained in more detail with reference to the Figures. In the Figures:

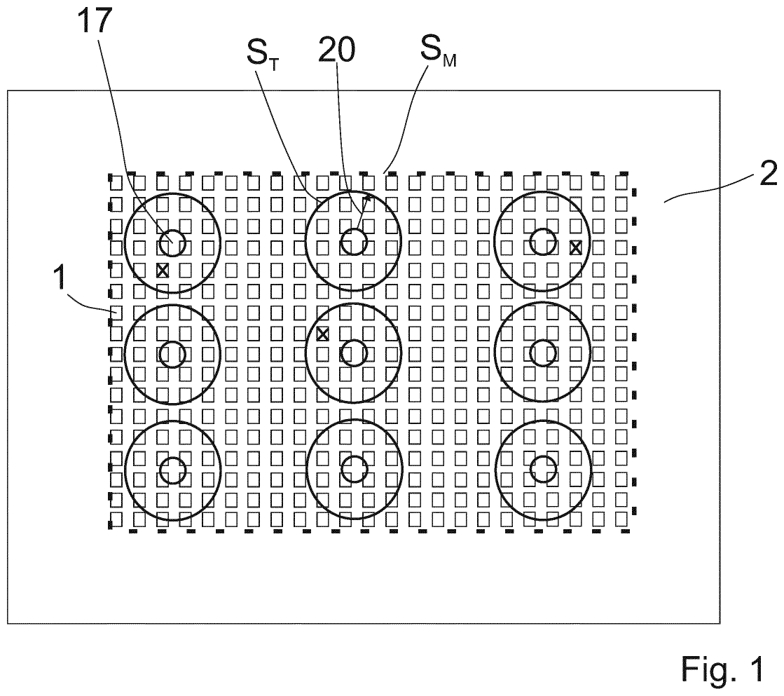

FIG. 1 shows a schematic illustration of a workpiece surface, which can be processed with the laser processing device according to the invention or the method according to the invention, with a periodic arrangement of processing sites, wherein only a predetermined number of the processing sites is to be processed (e.g. flaws or bores), and a two-dimensional laser spot arrangement that can be imaged on the workpiece surface by means of a laser processing device according to the invention;

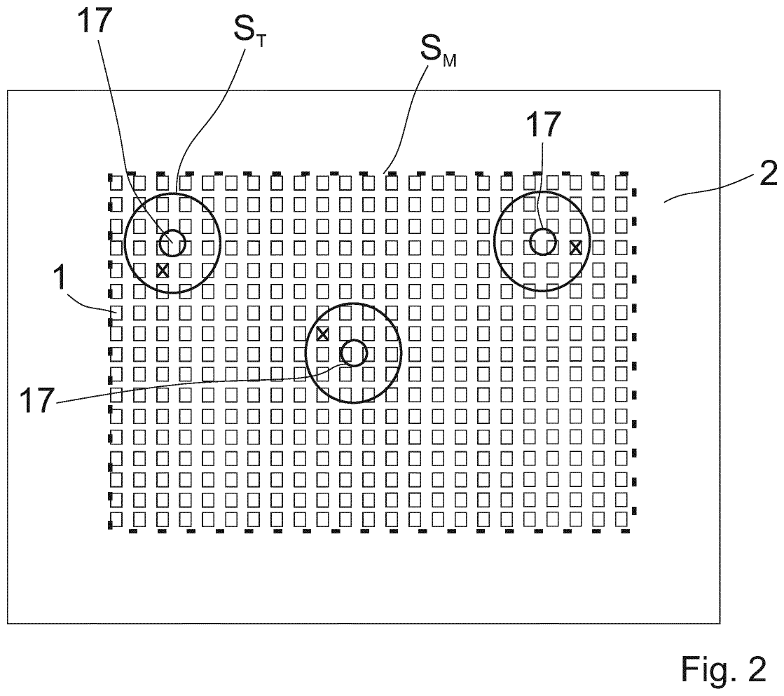

FIG. 2 shows a schematic view of a two-dimensional laser spot arrangement that can be imaged on the workpiece surface by means of the laser processing device according to the invention, wherein it is illustrated that, according to the invention, any number of laser spots can be imaged in any arrangement in space on the workpiece;

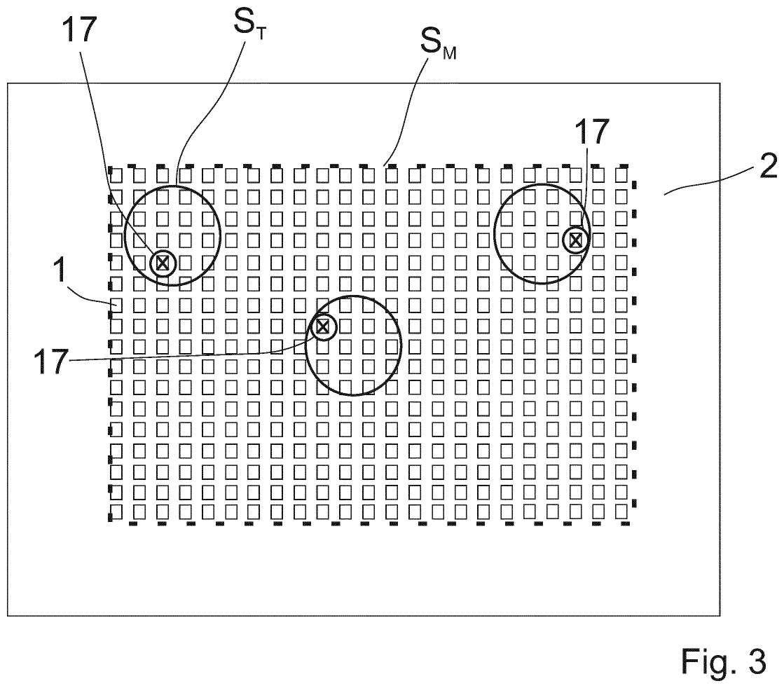

FIG. 3 shows a schematic view of a two-dimensional laser spot arrangement that can be imaged on the workpiece surface by means of the laser processing device according to the invention, wherein it is illustrated that, according to the invention, each partial beam or associated laser spot can be positioned within a partial beam scanning region at different positions, i.e. at the sites that are actually to be processed;

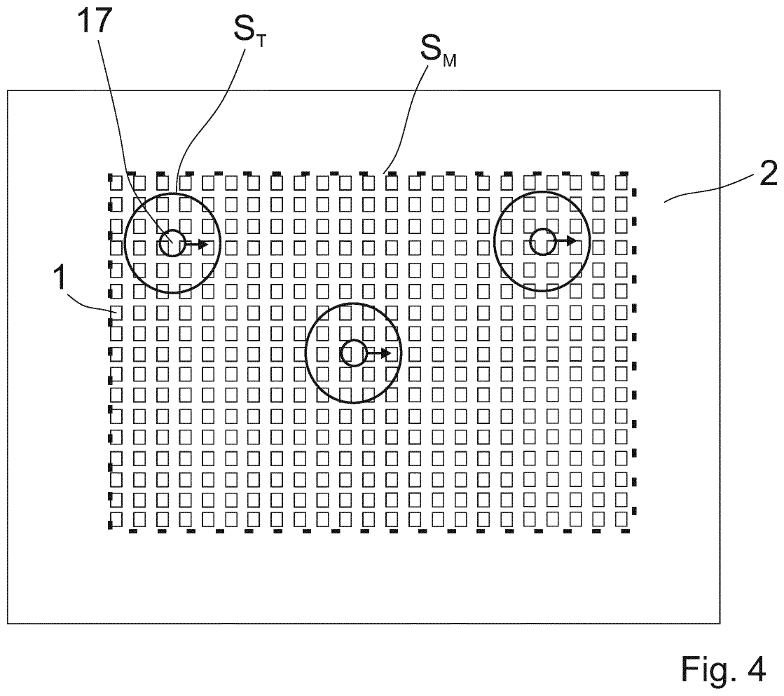

FIG. 4 shows a schematic view of a two-dimensional laser spot arrangement that can be imaged on the workpiece surface by means of the laser processing device according to the invention, wherein it is illustrated that the partial beams or associated laser spots are simultaneously and synchronously subjected to a joint scanning movement;

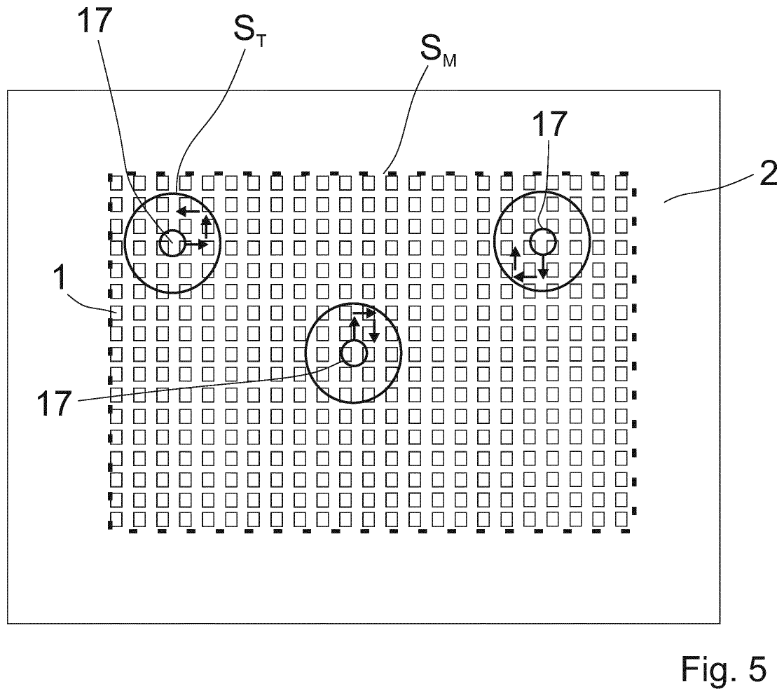

FIG. 5 shows a schematic view of a two-dimensional laser spot arrangement that can be imaged on the workpiece surface by means of the laser processing device according to the invention, wherein it is illustrated that the partial beams or associated laser spots are subjected to an individual scanning movement;

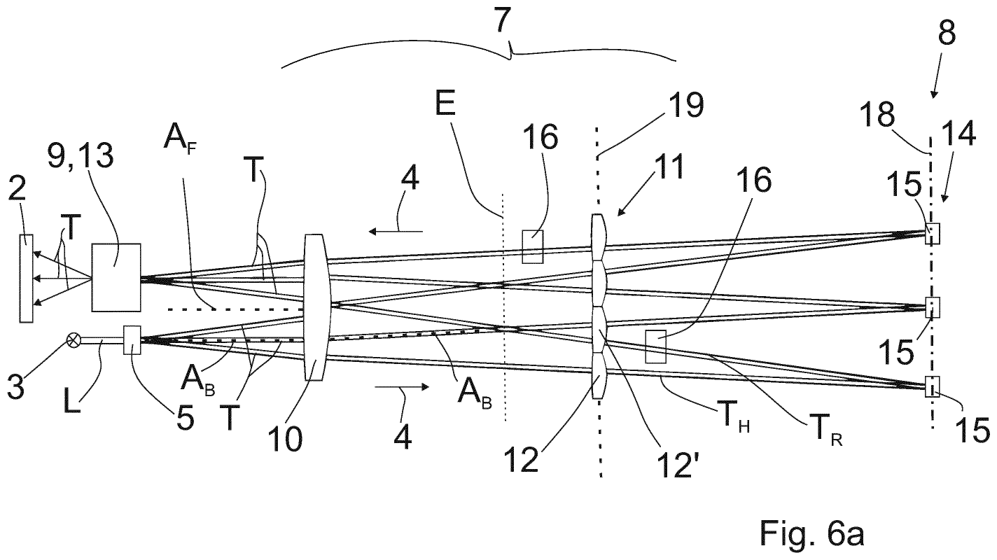

FIG. 6a shows the schematic structure of a laser processing device according to the invention;

FIG. 6b shows an example of a possible beam trajectory in a laser processing device according to FIG. 6a;

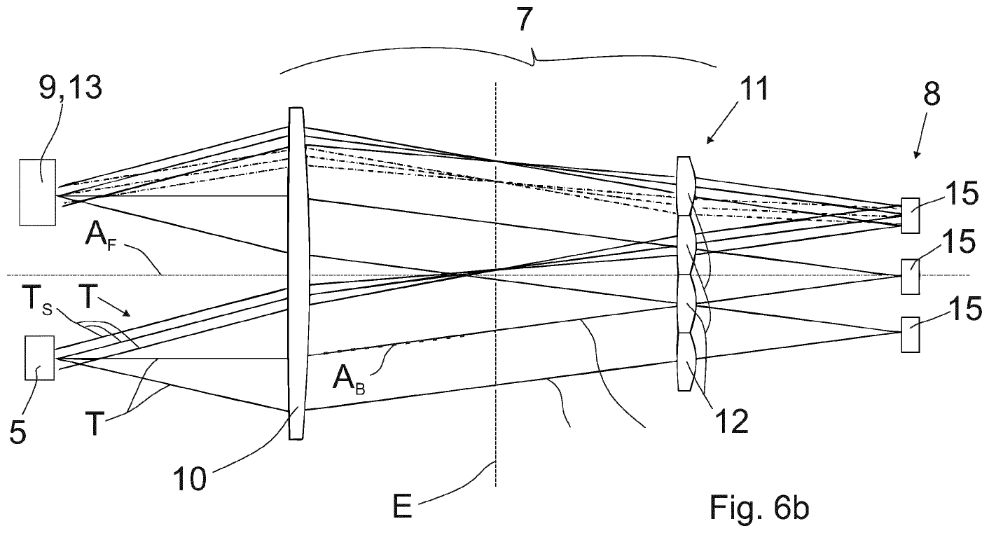

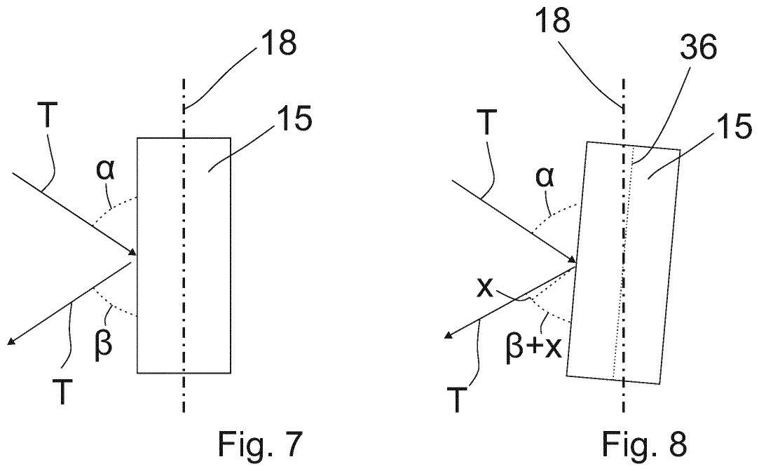

FIGS. 7, 8 show a schematic view regarding the functional principle of the optical control unit that is a part of the laser processing device, particularly of the microscanners;

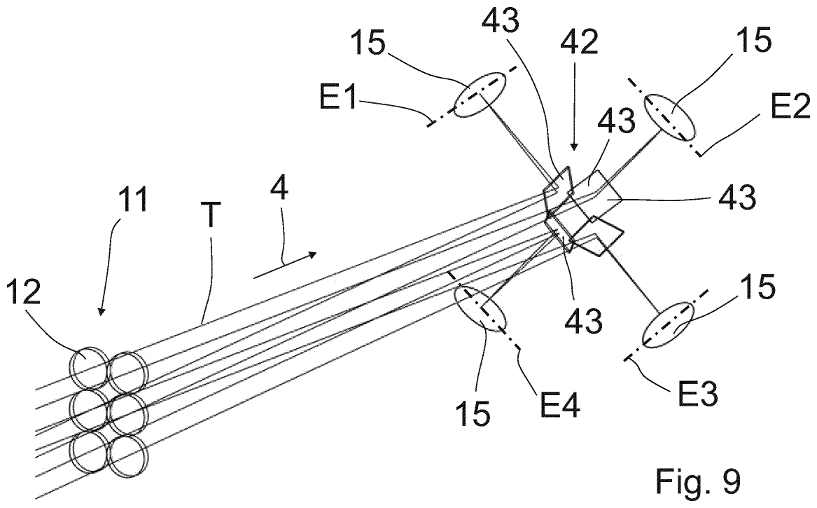

FIG. 9 shows a schematic perspective view of a part of the laser processing device according to another embodiment of the invention;

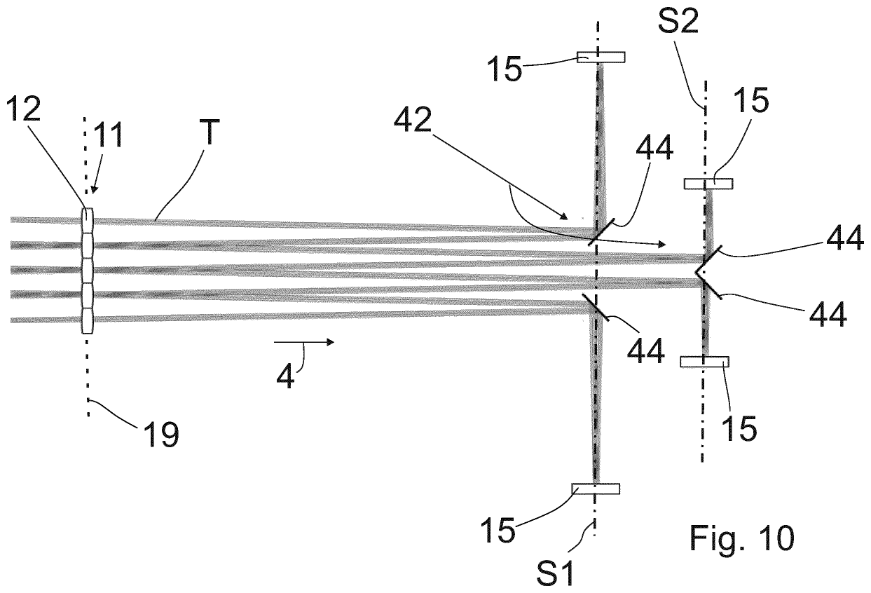

FIG. 10 shows a schematic cross-sectional view of a part of the laser processing device according to another embodiment of the invention;

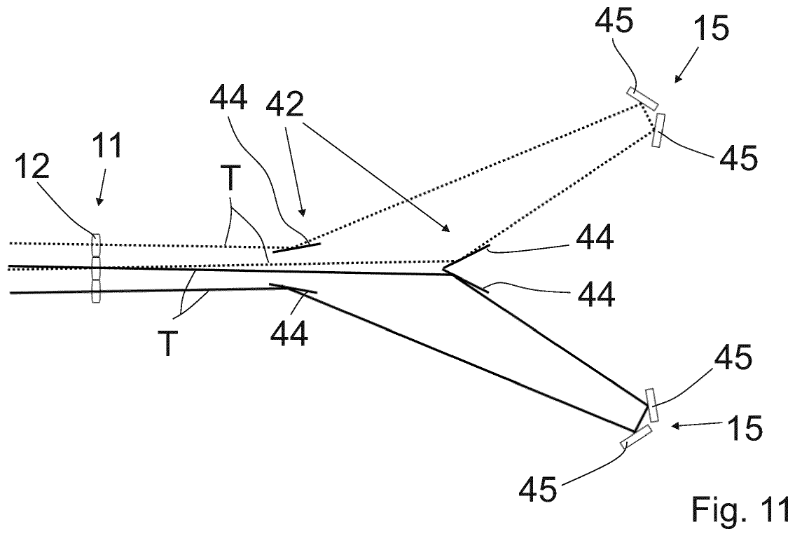

FIG. 11 shows a schematic cross-sectional view of a part of the laser processing device according to another embodiment of the invention.

The laser processing device proposed with the invention, or the associated method, are suitable for processing or repairing several processing sites 1 simultaneously in a workpiece 2 or associated surface. In particular, the present invention relates to the repair of displays or display components, e.g. OLED displays or mini LED displays. Particularly preferably, the present invention (laser processing device, method) is also suitable for carrying out drilling processes (e.g. in ceramic materials). On the one hand, static processing, but on the other hand also scanning processing can thus be carried out at the above-mentioned processing sites. The possibilities for an application of the invention mentioned here are not all-encompassing.

As was already described above, the laser processing device according to the invention, or the associated method, is suitable in particular for processing sites 1 of a workpiece 2, e.g. of flaws or bore positions. Before specifically discussing the details of the laser processing device according to the invention, the basic principle of the fundamental processing principle on which the invention is based will be explained in general terms with reference to the FIGS. 1 to 5.

FIG. 1 schematically shows a workpiece 2 to be processed with a (periodic) grid or pattern of a plurality of processing sites 1 that can be processed in principle. The processing sites 1 that can be processed in principle may constitute a periodic structure of pixels of the workpiece 2, for example. In the present case, a matrix of possible processing sites 1 is shown, of which certain processing sites 1 are intended to be processed (be it for repair, for example, or for carrying out a drilling process at the above-mentioned sites). In the present case, as an example, three of the processing sites 1 or pixels that can be processed in principle are labeled with a cross, which is supposed to represent that a corresponding laser processing is to be carried out at these sites. The processing sites 1 may include sub-structures (not shown). In the following, it may be assumed in one's mind that the labeled processing sites 1 have to be processed (e.g. repaired or drilled) by means of laser processing, e.g. because of local material inhomogeneities, layer thickness fluctuations or a desired bore, etc.

FIG. 1 further shows a configuration of laser spots 17, or a two-dimensional array of three-by-three laser spots 17, which are disposed within a master scanning region S_{M} and imaged on the workpiece 2. The master scanning region S_{M} defines a region which is in principle accessible for laser processing by projecting the partial beams T onto the workpiece surface, i.e. without additionally positioning the workpiece 2 relative to the laser processing device or vice versa. However, this does not preclude the possibility of the partial beams T or laser spots 17 located within the master scanning region S_{M} being shifted together (i.e. the master scanning region S_{M}) relative to the workpiece 2, or of the workpiece 2 being shifted relative to the master scanning region S_{M} or the partial beams T (or laser spots 17) disposed therein. This may be done by using a beam positioning unit 9, for instance, with which the partial beams T located within the master scanning region S_{M} can be synchronously and simultaneously shifted on the surface of the workpiece 2. It is also possible to image only a predetermined number of partial beams T on the workpiece 2 and move and/or position them synchronously and simultaneously on the surface of the workpiece 2 (this may also be carried out using a beam positioning unit 9). It may be emphasized that a relative displacement of laser spots 17 imaged on the workpiece 2 may also take place by moving or positioning the workpiece 2 relative to statically orientated (or moving) partial beams T.

According to the invention, the laser spots 17 result from a beam splitting of a laser beam L carried out with a beam splitting unit 5 in the laser processing device (in this respect, see FIG. 6). Selecting, by means of a corresponding partial beam selection, from the array of the laser spots 17 only those laser spots 17 that are necessary for processing the processing sites 1 provided and imaging them on the workpiece 2, i.e. three laser spots 17 in the example according to FIG. 2, is one of the core ideas of the invention. At the same time -as was already mentioned—it is also possible to carry out parallel processing on the processing sites 1 of a periodic processing pattern with the maximum number of partial beams T or the associated laser spots 17 (the maximum number is determined by the beam splitting unit 5).

In the example according to FIG. 1, however, the three-by-three laser spots 17 imaged on the workpiece 2 are not directed towards the processing sites to be processed (see the processing sites 1 labeled with a cross). As was already mentioned, however, the laser processing device is configured for directing also only a predetermined number of partial beams T (or associated laser spots 17) of a maximum possible number of partial beams T (or laser spots 17) towards the workpiece 2. In FIG. 2, only those partial beams T (or associated laser spots 17) are directed towards the workpiece 2 into whose partial beam scanning region S_{T} the sites to be processed (labeled with a cross) fall. The partial beam scanning region S_{T} is the region of a partial beam T in which the latter, or an associated laser spot 17, can be individually and flexibly positioned and/or scanned by means of an optical control unit associated with the laser processing device (independently of the other partial beams T). The scanning region 20 is schematically illustrated with an arrow in FIG. 1. Given a positioning of the laser spots 17 in accordance with FIG. 2, no processing of the processing sites 1 labeled with the cross would be possible. Accordingly, the laser spots 17 or the partial beams T can be individually positioned within the respective partial beam scanning regions S_{T} (see FIG. 3), i.e. in the region of the sites that are actually to be processed.

After the laser spots 17 have been positioned, the processing of the sites to be processed can take place. However, it is also readily possible to subject the partial beams T or laser spots 17 to a processing movement. In a first variant - as is illustrated with the arrows in FIG. 4—this may proceed in a synchronous and simultaneous manner. As is shown in FIG. 4, also only a predetermined number of the partial beams T or associated laser spots 17 directed towards the workpiece 2 may in this case be subjected to the above-mentioned movement. Such a synchronous and simultaneous movement of partial beams T of laser spots 17 is preferably provided by a beam positioning unit 9. At the same time, the workpiece 2 may also be moved relative to static or moving partial beams T. Alternatively, it is also possible to subject the respective partial beams T directed towards the workpiece 2 to an individual processing movement (scanning movement) within the partial beam scanning region S_{T}. In that case, the movement is not carried out synchronously but individually for each partial beam T. This is illustrated in FIG. 5, in which the different paths of movement of the scanning movement of the individual partial beams T or laser spots 17 are indicated with the arrows or arrow series therein, which point in different directions. As will be explained below, the individual scanning movement is carried out with the optical control unit.

Thus, an arbitrary configuration of laser spots 17 can be imaged on the workpiece 2 (adapted to a pattern of processing sites or flaws), limited in this case by the maximum number of partial beams T that can be generated by means of the beam splitting unit 5. A spot array (e.g. a 3×3 array) predefined by beam splitting is imaged on the workpiece 2 without a beam selection (FIG. 1).

Among other things, the method according to the invention or the laser processing device according to the invention is characterized in that such processing sites 1 can be simultaneously processed in a parallelized process, namely in an arbitrary spatial configuration. With respect to the example of repairing flaws, the method described with the present invention is more cost-effective and faster compared with repair techniques based on single-beam laser processing.

As is shown in FIGS. 1 to 4, the laser processing device proposed with the present invention is capable of projecting a plurality of partial beams T formed from a laser beam L onto the workpiece 2 to be processed; that is, an array or a bundle of partial beams T can be imaged on the workpiece 2. The number and arrangement in space of the partial beams T imaged on the workpiece 2 can be flexibly adjusted. Thus, the partial beams T are flexibly switchable; i.e., even only individual ones of the partial beams T associated with the array may readily be directed towards the workpiece 2 (FIG. 2). With the laser processing device according to the invention, it is thus possible to apply laser radiation (or the laser spots formed by the partial beams T) to the workpiece 2 selectively at certain processing sites 1, at which sites to be processed (see, for example, the processing sites 1 in FIGS. 2 and 3 labeled with a cross) are formed. In the case of flaw repair, excess material of the workpiece 2 present at these processing sites 1 can be ablated by means of laser processing, for example. Thus, processing sites 1 of the workpiece 2 can be processed both within a predetermined master scanning region S_{M} (meaning a processing region spanned by the partial beams T projected onto the workpiece 2) and beyond this scanning region. The latter is possible particularly by a relative displacement of the workpiece 2 with respect to the positionally fixed laser processing device, alternatively also by displacing the master scanning region S_{M} with respect to the workpiece surface (e.g. by means of a beam positioning unit 9), which is shown in FIG. 4, for example. A combination of a relative displacement of the workpiece 2 relative to the laser processing device and a scanning movement of the master scanning region S_{M} including the partial beams T directed towards the workpiece 2, which is carried out by the laser processing device, particularly by a beam positioning unit 9, is also possible.

In contrast to the laser processing devices or methods known from the prior art, the laser processing device (and the method) proposed with the present invention is not limited to imaging individual lines or columns of an array of partial beams T on the workpiece 2, but rather, geometrically arbitrary combinations of spot arrangements can be provided on the workpiece 2. It is not necessary to commit to a certain spatial pattern or a number of the partial beams T; rather, any partial beams T of the bundle of partial beams T provided by the beam splitting unit 5 may be selected and transferred in the direction of the workpiece 2 by the optical control unit (the latter may also include a beam selecting unit 16).

Another core feature of the invention relates to the individual positionability of each partial beam T in a partial beam scanning region S_{T} (FIGS. 3, 5), wherein the partial beam scanning region S_{T} includes a smaller lateral extent than the above-mentioned master scanning region S_{M}. Thus, the master scanning region S_{M} includes a number of partial beam scanning regions S_{T} corresponding to the number of partial beams T directed towards the workpiece 2. As will be explained in more detail below by describing the structure of the design of the laser processing device with reference to FIG. 5, each of the partial beams T directed towards the workpiece 2 can be individually positioned at different sites (FIG. 3) within a partial beam scanning region S_{T} or moved within this region (FIG. 5) by means of an optical control unit. The individual positioning or movement of each partial beam T within the respective partial beam scanning region S_{T} is carried out independently of the other partial beams T. Each of the partial beams T can be individually controlled by means of the optical control unit. Accordingly, the laser processing device proposed with the invention is not only suitable for processing periodically arranged processing patterns or processing sites 1, but also for processing non-periodically or partially periodically arranged processing sites 1. The capability for individually positioning laser spots 17 associated with the partial beams T is depicted in FIG. 3, wherein the laser spots 17 are not arranged centrally in the partial beam scanning region S_{T}, but rather in the regions of the sites to be processed (processing sites 1 marked with a cross). FIG. 5 illustrates that the partial beams T directed towards the workpiece 2, or the associated laser spots 17, may also undergo an individual scanning movement, which is carried out within the respective partial beam scanning regions S_{T}. In this case, the scanning movements of the individual partial beams T or laser spots 17 can traverse different movement paths (illustrated by the sequences of arrows).

The schematic structure of the laser processing device according to the invention is presented in FIG. 6a. The illustration therein is a schematic representation. Meanwhile, the specific beam trajectory is presented in detail in an exemplary example in FIG. 6b, namely for a beam splitting process of a laser beam L generated by a laser radiation source 3 into three partial beams T, which in turn comprise three sub-partial beams T_{S} each. On the workpiece 2, the sub-partial beams T_{S} (depicted for only one of the partial beams T) are focused on a laser spot, which is why, with respect to a partial beam T or a laser spot associated with the partial beam T, it must be taken into account in the present description that the beam trajectory relates to a number of sub-partial beams T_{S}. FIG. 6b illustrates the detailed course of the partial beams T or sub-partial beams T_{S} starting from a beam splitting unit 5 up to a beam positioning unit 9.

In order to process a workpiece 2 with a laser processing device according to the invention, the workpiece 2 is disposed in a workpiece holder, which is not depicted. The workpiece holder may be configured in the form of an xy-table that can be moved in a horizontal plane.

As shown in FIG. 6a, the laser processing device first of all comprises a laser radiation source 3, with which a laser beam L is generated and emitted along an optical path 4 in the direction of the workpiece 2, in particular in the form of laser pulses. A beam splitting unit 5 is disposed downstream of the laser radiation source 3 in the beam direction. The beam splitting unit 5 is configured for splitting the laser beam L into a plurality of partial beams T. The beam splitting unit 5 may be a diffractive optical element (DOE) known per se, or an SLM. The number of partial beams T can already be preset with the beam splitting unit 5. A rough adjustment of the distances between the laser spots of the partial beams T present in a plane of the workpiece 2 can also be already set with the beam splitting unit 5. A laser beam L can be divided with the beam splitting unit 5 into partial beams T that provide a two-dimensional spatial pattern of laser spots 17 on the workpiece 2. As can be seen in FIG. 6b, each partial beam T comprises a number (in this case three) of sub-partial beams T_{S}, which in the present case may be referred to, as a combination, as partial beams T or main beams H_{S}. Only the course of the main beams H_{S} is shown in FIG. 6a.

Starting from the laser radiation source 3, a collimated laser beam L thus hits the beam splitting unit 5. The beam splitting unit 5 splits the laser beam into a bundle of identical partial beams T that each have a defined angle to one another.

A beam shaping element may be provided (not shown) between the laser radiation source 3 and the beam splitting unit 5, with which, in combination with the beam splitting unit 5, a plurality of partial beams T with a predetermined intensity distribution, e.g. a top-hat intensity distribution or ring-shaped intensity distribution, can be generated on the workpiece from a laser beam L with a Gaussian intensity distribution.

The laser processing device shown in FIGS. 6a and 6b includes an optical functional unit 7 disposed between the beam splitting unit 5 and a reflective optical functional unit 8. In this case, the optical functional unit 7 (which may be configured to be transmissive, but does not have to be) includes a group of optical functional elements 10, 12 disposed one behind the other. Thus, the (in this case transmissive) optical functional unit 7 comprises a focusing unit 10 (which may be formed of successively arranged lenses or lens systems, for example) and a lens array 11 of lenses 12 disposed at a distance from the focusing unit 10. In this case, the lens array 11 always comprises one more “line” or “column” of lenses 12 compared with the number of microscanners 15 in the array 14.

In the sense of the invention, a transmissive optical functional unit 7 is to be understood such that the components associated with the transmissive optical functional unit (the focusing unit 10 and the lens array 11) are penetrated by the partial beams T. In contrast, the partial beams T are reflected on the reflective optical functional unit 8.

On a first beam track up to being reflected on the reflective optical functional unit 8, the partial beams T associated with the bundle of partial beams T pass through the focusing unit 10 and the lens array 11 (see, for example, the propagation of the lower partial beam T_{H} in FIG. 6a, or of the upper partial beam T including the sub-partial beams Ts in FIG. 6b). After the reflection T on the reflective optical functional unit 8, at least a portion of the partial beams T reflected thereon again passes through the optical functional unit 7 on a second beam track, particularly through the lens array 11 and the focusing unit 10. Subsequent to the beam splitting process in the beam splitting unit 5, the partial beams T accordingly propagate as a bundle of collimated partial beams T in the direction of the focusing unit 10. The partial beams T are collimated and focused by the focusing unit 10.

As can be seen from the course of the partial beam T_{H} in FIG. 6a or of the partial beams T in FIG. 6b, for example, each partial beam T of the bundle of partial beams T, on the first beam track, passes through a lens 12 of the lens array 11 assigned to the respective partial beam T. The sub-partial beams T_{S} of a respective partial beam T also pass through a common lens 12 (FIG. 6b). On the second beam track, at least a portion of the partial beams T reflected on the reflective optical functional unit 8 again pass through the lens 12 of the lens array 11 assigned to the respective partial beam T. Depending on the number of partial beams T to be imaged on the workpiece 2, a portion of the reflected partial beams T may be deflected by the reflective optical control unit 8 in the direction of a beam selecting unit 16, whereby the partial beam T is removed or absorbed from the beam path. Thus, it may be provided that not all of the partial beams T passing through the focusing unit 10 and the lens array 11 on the first beam track end up in the direction of the workpiece 2, but are previously (preferably on the second beam track) deflected or removed from the beam path by suitable means. A partial beam T can be removed or deflected from the beam path either by means of a beam selecting unit 16 provided specifically for this purpose (it may deflect a partial beam T from the beam path, e.g. in the direction of a beam dump), or a partial beam T is directed in the direction of a beam selecting unit 16 or of a beam dump by the reflective optical functional unit 8. In accordance with the number of partial beams T required for processing at a given position of the master scanning region S_{M} on the workpiece 2, the corresponding number of non-required partial beams T can thus be deflected or removed from the beam path of the partial beams T.

As FIGS. 6a and 6b also make apparent, the focusing unit 10 is arranged in such a manner that a partial beam bundle axis A_{B}, prior to the partial beams T hitting the focusing unit 10 on the first beam track, is offset relative to an axis of symmetry A_{F} of the focusing unit 10 extending along the optical path 4. The offset of the bundle of partial beams T or of the partial beam bundle axis A_{B} relative to the axis of symmetry A_{F} of the focusing unit 10 causes the partial beam bundle axis A_{B} to extend at an angle to the axis of symmetry A_{F} of the focusing unit 10 subsequent to passing through the focusing unit 10, of which an impression is shown in FIG. 6b.

It can also be seen that the bundle of partial beams T, subsequent to passing through the focusing unit 10 on the first beam track, has a telecentric beam path. This can be seen particularly well in the detailed illustration of FIG. 6b. As is shown therein, the partial beams T (here, a bundle of three partial beams T is shown by way of example), is respectively composed of a bundle of a predetermined number of sub-partial beams T_{S} (shown for the upper partial beam T). A telecentric beam path is understood to mean that the sub-partial beams T_{S} can each be described by a main beam H_{S}, wherein the main beams H_{S} are parallel to one another after passing through the focusing unit 10. The main beams H_{S} are composed of sub-partial beams T_{S}.

The partial beams T of the bundle of partial beams T are focused on the first beam track in a plane E disposed perpendicular to the optical path 4 or to the axis of symmetry A_{F} of the focusing unit 10, wherein the plane E is preferably disposed between the focusing unit 10 and the lens array 11. Also on the second beam track, it may be advantageous to focus the partial beams T of the bundle of partial beams T in the above-mentioned plane E after they have passed through the lens array 11.

The lens array 11 comprises a lateral (two-dimensional) assembly of lenses or lens systems 12, which are disposed in a common lens plane 19, wherein the lens plane 19 is disposed perpendicular to the optical path 4 or to the axis of symmetry A_{F} of the focusing unit 10. In this case, the lenses 12 of the lens array 11 are arranged in such a way that each partial beam T (including the sub-partial beams T_{S}) of the bundle of partial beams T passes through one lens 12 in each case. Such an assembly permits a separation of the partial beams into separate optical channels. Each partial beam T passing through the lens array 11 or the individual lenses 12 is collimated by the respective lens 12 of the lens array 11. The distance between the focusing unit 10 and the lens array 11 is selected such that the partial beams T are substantially collimated after passing through the lens array 11. After the partial beams T have passed through the lens array 11, the partial beams T propagate in the respective optical channels on the first beam track until they hit the reflective optical functional unit 8. On the whole, the distances and focal lengths of the optical components are selected in such a way that a beam splitting plane in the beam splitting unit is imaged onto the individual microscanners 15, and the microscanners 15 are equally imaged onto a common plane. This is done by combining the focusing unit 10 and the lens array 11. It is accomplished by the above-mentioned second imaging that the individual optical channels cross each other in a plane - even if an individually set partial beam direction is changed.

The optical functional unit 8 is formed from an array 14 of reflective microscanners 15. The array 14 of reflective microscanners 15 is preferably configured in a lateral two-dimensional assembly of reflective microscanners 15, wherein the microscanners 15 are disposed in a common microscanner plane 36. The microscanner plane 36 extends perpendicularly to the optical path 4 or to the axis of symmetry A_{F} of the focusing unit 10. In this case, the reflective microscanners 15 are arranged in such a way that one partial beam T (or the associated sub-partial beams T_{S}) is in each case reflected by one microscanner 15. The angle of incidence a of each partial beam T on the respective reflective microscanner 15 in this case approximately corresponds to the above-mentioned angle between the partial beam bundle axis A_{B} and the axis of symmetry A_{F} of the focusing unit 10. Accordingly, the number of the reflective microscanners 15 corresponds to the number of partial beams T extending along the first beam track. After a respective partial beam T has hit a reflective microscanner 15, the partial beam T is reflected on this microscanner 15.

As is illustrated, in particular, in FIGS. 7 and 8, an additional angle value x can be added (FIG. 8) with a respective microscanner 15 to a partial beam T incident on the microscanner, compared with a simple reflection according to the principle angle of incidence α=angle of reflection β (FIG. 7). This can be effected by tilting the microscanner 15 from a basic position. As is shown in FIG. 8, the microscanner 15 can in this case be tilted with its microscanner axis 36 relative to a microscanner plane 18. The additional addition of an angle in the end permits an additional offset of the laser spots 17 imaged on the workpiece 2 and a capability of the laser spots 17 to be positioned or moved within the respective partial beam scanning regions S_{T}.

Thus, an angle of deflection of the partial beams T can be adjusted with the respective microscanners 15 in a flexible manner. In this case, the microscanners are adjusted preferably in a mechanical manner, wherein the deflection angles are adjusted by means of a control unit (not shown) connected to the array 14 of microscanners 15 or the individual microscanners 15.

After the partial beams T have passed through the lens array 11 on the second beam track, the above-mentioned addition of an angle results in a lateral offset of the respective focal point of the partial beams T in the plane E. Consequently, the angular deflection induced with the microscanners 15 has an effect on the position of the partial beams T directed towards the workpiece 2. In this case, the plane E (which may also be referred to as an intermediate focal plane) is imaged in the processing plane of an objective associated with the beam positioning unit 9.

The respective collimated partial beams T propagate along the second beam track back to the lens array 11 subsequent to being reflected at the microscanners 15. Depending on the angular deflection at the reflective array 14 of microscanners 15, the partial beams T now have an additional angular deflection compared with a partial beam T reflected on a microscanner 15 in the basic position (in accordance with FIG. 7). The bundle of collimated partial beams T again hits the lens array 11. In the process, a substantially collimated partial beam T passes through exactly one lens 12 of the lens array 11. Conversely, each lens 12 of the lens array 11 is penetrated by exactly one partial beam T of the bundle of partial beams reflected on the array 14 of microscanners 15. On the first beam track (i.e. the beam track from the focusing lens 10 to the lens array 11) and the second beam track (i.e. the beam track from the array 14 of microscanners 15 to the lens array 11), a partial beam T thus penetrates the lens array 11 twice with a different, in particular opposite, propagating direction.

As is illustrated in the FIGS. 6a and 6b, a partial beam T_{R} (including sub-partial beams Ts, see FIG. 6b), on the second beam track, passes through a lens 12′ of the lens array 11, which is disposed adjacent to a lens 12 of the lens array 11 through which the partial beam Tx passes on the first beam track. Thus, the partial beams T on the first beam track (which may also be referred to as the forward journey of the partial beams T towards the reflective optical functional unit 8) pass through a different lens 12 of the lens array 11 than on the second beam track (which may also be referred to as the return journey of the partial beams T back from the reflective optical functional unit 8). The lenses 12, 12′ though which a single partial beam T passes on the first and the second beam track are preferably—but not necessarily—adjacently disposed. Only due to this fact is a separation (which is to be understood to be a separation into solid angle directions) of the channels on the forward and return journeys made possible by the array 14 of microscanners 15.

As was already mentioned and depicted in FIGS. 6a and 6b, the partial beams T again pass through the focusing unit 10 as a bundle of partial beams T on the second beam track, wherein the partial beam bundle axis A_{B}, prior to the partial beams T hitting the focusing unit 10 on the second beam track, is offset relative to the axis of symmetry A_{F} of the focusing unit extending along the optical path 4. At this point, it must be emphasized that the focusing unit 10 causes the partial beams T of the bundle of partial beams passing through the focusing unit 10 on the second beam track to converge; that is, the optical axes of the partial beams T run towards one another (in the case of the telecentric beam trajectory mentioned above, the partial beams even meet at a point in space). In the general case, however, the symmetry of the arrangement of the partial beams about the common partial beam bundle axis A_{B} is broken, because each partial beam may have a different angle (because of the individual angle addition by the reflective optical functional unit 8). Preferably, the focusing unit 10 collimates every partial beam T passing through the focusing unit 10.

The laser processing device shown in the exemplary embodiment according to FIGS. 6a and 6b also includes a beam positioning unit 9, particularly in the form of a galvanometer scanner, which is configured for carrying out a rough positioning process, relative to the workpiece 2, of the partial beams T directed towards the workpiece 2, namely by positioning a master scanning region S_{M} including the partial beam scanning regions S_{T} relative to the workpiece 2. At the respective positions of the master scanning regions S_{M} (and thus of the partial beams T) set by means of the rough positioning process, an individual fine positioning process of the partial beams T may be carried out within predetermined partial beam scanning regions S_{T} of the respective partial beams T, subsequent to the rough positioning process. All of the partial beams T directed towards the workpiece 2 are thus delivered by means of the beam positioning unit 9.

With the beam positioning unit 9, the partial beams T directed towards the workpiece 2 can be moved, preferably synchronously and simultaneously, across the workpiece 2, namely by moving the master scanning region S_{M} including the partial beam scanning regions S_{T} relative to the workpiece 2.

The beam positioning unit 9 is downstream of the optical control unit 6 with respect to the beam direction or the beam path; thus, the beam path of the partial beams T is configured such that the partial beams T hit the beam positioning unit 9 only after being reflected at the reflective optical control unit 6. As was already mentioned several times, individual scanning programs or scanning movements can be executed also for the individual partial beams T or laser spots 17 imaged on the workpiece 2.

With respect to the second beam track, a focusing optics unit 13, with which the partial beams T (directed towards the workpiece 2) are focused on the workpiece 2 while forming laser spots 17, is disposed downstream of the beam positioning unit. For example, the focusing optics unit 13 may be configured as a lens, preferably as a F-theta lens, which is also referred to as a flat field lens.

FIG. 9 shows a schematic perspective view of a part of the inventive laser processing device according to another embodiment of the invention. What is shown is the beam trajectory or structure in the region between the lens array 11 and the reflective optical functional unit 8. Also shown is an assembly with a 2×2 assembly of microscanners 15.

As was already mentioned in the general part of the description, it is possible to deviate from arranging the micro scanners 15 in the form of an array 14 of microscanners 15 disposed in a microscanner plane 18 parallel to the lens array 11. This is done by carrying out an additional deflection of the partial beam bundles or partial beams T between the lens array 11 and the microscanners 15. The microscanners 15 may then be disposed at different positions in space.

As is shown in FIG. 9, a mirror device 42 is disposed between the lens array 11 and the microscanners 15, which is disposed and configured such that the partial beams T passing through the lens array 11 or the lenses 12 on the first beam track are respectively directed in the direction of one of the microscanners 15, and the partial beams T reflected at the microscanners 15 are each directed in the direction of the lens array 11 on the second beam track. With respect to the optical path 4, the partial beams T in the exemplary embodiment according to FIG. 9 are directed radially outward, for example, whereby the laser processing device can be given a more compact configuration (particularly in the direction of the optical path 4) and more construction space is available for arranging the microscanners.

The mirror device 42 shown in FIG. 9 has a plurality of mirror surfaces 43, wherein each mirror surface 43 is configured so as to deflect a partial beam T passing through the lens array 11 or a lens 12 of the same on the first beam track in the direction of one of the microscanners 15, and to deflect a partial beam T reflected at one of the microscanners 15 in the direction of the lens array 11 on the second beam track. In the example shown in FIG. 9, the mirror device 42 is a pyramid mirror. Such an arrangement makes it possible to dispose the microscanners 15 in different planes E1, E2, E3, E4 (indicated by chain-dotted lines), wherein the planes E1, E2, E3, E4 are each situated at an angle to the lens plane 19. Thus, construction space is saved and the laser processing device can be given a more compact configuration.

According to another variant (see FIG. 10), the deflection may take place in different planes along the beam propagation, so that the arrangement positions of the microscanners 15 (compared with the arrangement of the microscanners 15 in a common microscanner plane 18) can also be separated.

As is shown in FIG. 10, the mirror device 42 comprises for this purpose a plurality of mirrors 44, wherein a first number of the mirrors 44 is disposed in a first mirror plane S1 and a second number of the mirrors 44 in a second mirror plane S2, wherein the mirror planes S1, S2 are disposed preferably perpendicularly to the optical path 4 or to the axis of symmetry A_{F} and spaced apart from each other. In the depicted example, the mirror planes S1, S2 are disposed parallel to the lens plane 19.

In this case, the mirrors 44 disposed in the mirror planes S1, S2 are disposed at an angle to the mirror planes S1, S2. Each mirror 44 is configured so as to direct a partial beam T passing through the lens array 11 on the first beam track in the direction of one of the microscanners 15, and to direct a partial beam T reflected at one of the microscanners 15 in the direction of the lens array 11 on the second beam track.

FIG. 11 shows another embodiment of the invention, in which galvanometer scanners are used as microscanners 15, instead of micromirrors or MEMS mirrors/MEMS scanners. The microscanners 15 configured in this manner have two mirror elements 45 with separate scanner axes. Each of the microscanners 15 is configured for deflecting in two coordinate directions a partial beam T hitting it. A perfect telecentricity cannot be achieved by separating the scanner axes to two mirror elements 45. However, even in the case of today's single-beam scanner systems, this small deviation does not constitute a great limitation.

As is shown in FIG. 11, a mirror device 42 in the form of several mirrors 44 is provided also in the case of such a configuration of the microscanners 15. The deflection of the partial beams T is depicted with dotted and continuous lines for two exemplary beam trajectories. The laser processing device can be given a compact configuration also in this exemplary embodiment, because the size of the lens array is largely uncoupled from the dimensions of the microscanners or the microscanner assembly.

### LIST OF REFERENCE NUMERALS

1 Processing site
2 Workpiece
3 Laser radiation source
4 Optical path
5 Beam splitting unit
7 Optical functional unit
8 Reflective optical functional unit
9 Beam positioning unit
10 Focusing unit
11 Lens array
12 Lens
13 Focusing optics unit, F-theta lens
14 Array
15 Microscanner
16 Beam selecting unit
17 Laser spot
18 Microscanner plane
19 Lens plane
20 Scanning region
36 Microscanner axis
40 Workpiece holder
42 Mirror device
43 Mirror surface
44 Mirror
45 Mirror element
L Laser beam
T Partial beam
Tx Partial beam
TR Partial beam
Ts Sub-partial beam
A_{B} Partial beam bundle axis
A_{F} Axis of symmetry
E Plane
E1 Plane
E2 Plane
E3 Plane
E4 Plane
H_{S} Main beam
S_{T} Partial beam scanning region
S_{M} Master scanning region
S1 First mirror plane
S2 Second mirror plane
α Angle of incidence
β Angle of reflection
x Additional angle

1. A laser processing device comprising:
a. a laser radiation source (3) configured to generate a laser beam (L) and emit the laser beam (L) along an optical path (4) in a direction of a workpiece (2);
b. a beam splitting unit (5) located downstream of the laser radiation source (3) in said beam direction and configured to split the laser beam (L) into a bundle of partial beams (T); and
c. an optical control unit located downstream of the beam splitting unit (5) in the beam direction and comprising a reflective optical functional unit (8) including an array (14) of reflective microscanners (15), the optical control unit configured
to select from the bundle of partial beams (T) an arbitrary number of partial beams in an arbitrary spatial combination and direct them towards the workpiece (2), and
to position and/or move, within a predetermined partial beam scanning region (S_{T}) of a respective partial beam (T), at least one, of the partial beams (T) directed towards the workpiece (2) using a microscanner (15) of the array (14) of microscanners (15) assigned to the respective partial beam (T).

2. (canceled)

3. The laser processing device according to claim 1, further including an optical functional unit (7) located between the beam splitting unit (5) and the reflective optical functional unit (8) and comprising a group of optical functional elements (10, 11) located one behind the other.

4. The laser processing device according to claim 3, wherein the group of optical functional elements (10, 11) located one behind the other comprises:
a. a focusing unit (10) comprising one or several lenses, lens systems, mirrors located one behind the other, and/or any combination thereof,
b. a lens array (11) of lenses (12) spaced apart from the focusing unit (10).

5. The laser processing device according to claim 4, configured so that the partial beams (T) defining the bundle of partial beams (T) pass through the focusing unit (10) and the lens array (11), along a first beam track until being reflected at the reflective optical functional unit (8) and, subsequent to being reflected at the reflective optical functional unit (8), at least some of the partial beams (T) reflected thereby pass, along a second beam track, through the optical functional unit (7), namely the lens array (11) and the focusing unit (10).

6. The laser processing device according to claim 5, configured so that each partial beam (T) defining the bundle of partial beams (T) passes along the first beam track through a lens (12) of the lens array (11) assigned to the respective partial beam (T), and at least some of the partial beams (T) reflected at the reflective optical functional unit (8) pass along the second beam track through a lens (12) of the lens array (11) assigned to the respective partial beam (T).

7. (canceled)

8. The laser processing device according to claim 6, further including a beam selecting unit (16) configured to deflect or absorb a predetermined number of partial beams (T) so that the deflected or absorbed partial beams (T) do not hit the workpiece (2).

9-15. (canceled)

16. The laser processing device according to claim 4, wherein the lens array (11) comprises a lateral assembly of lenses (12) or lens system.

17. The laser processing device according to claim 1, wherein each respective partial beam (T) is reflected by a respective microscanner (15).

18-20. (canceled)

21. The laser processing device according to claim 5, configured so that the partial beams (T) reflected at the microscanners (15) pass through the lens array (11) along the second beam track, wherein a respective partial beam (T), along the first beam track, passes through a lens (12) of the lens array (11) located adjacent to a lens (12) of the lens array (11) through which the partial beam (T) passes along the second beam track.

22-24. (canceled)

25. The laser processing device according to claim 5, further including a mirror device (42) located between the lens array (11) and the microscanners (15) and configured to deflect respective partial beams (T) passing through the lens array (11) along the first beam track in a direction of one of the microscanners (15), and to direct the respective partial beams (T) reflected at the microscanners (15) in a direction of the lens array (11) along the second beam track.

26. The laser processing device according to claim 25, wherein the mirror device (42) has a plurality of mirror surfaces (43), wherein each mirror surface (43) is configured to deflect a partial beam (T) passing through the lens array (11) along the first beam track in a direction of one of the microscanners (15), and to deflect a partial beam (T) reflected at one of the microscanners (15) in a direction of the lens array (11) along the second beam track.

27. (canceled)

28. The laser processing device according to claim 16, wherein the lateral assembly of lenses (12) or lens systems are located in a common lens plane (19) and the microscanners (15) are located among a plurality of different planes, wherein the different planes are each situated at an angle to the lens plane (19).

29. The laser processing device according to claim 25, wherein the mirror device (42) comprises a plurality of mirrors (44), wherein a first number of the mirrors (44) is located in a first mirror plane (S1) and a second number of the mirrors (44) in a second mirror plane (S2).

30. The laser processing device according to claim 29, wherein the mirrors (44) located in the mirror planes (S1, S2) are oriented at an angle to the mirror planes (S1, S2).

31. The laser processing device according to claim 29, wherein each mirror (44) of the mirror device is configured to deflect a partial beam (T) passing through the lens array (11) along the first beam track in a direction of one of the microscanners (15), and to deflect a partial beam (T) reflected at one of the microscanners (15) in a direction of the lens array (11) along the second beam track.

32. A method comprising:
laser-processing a workpiece (2) at predetermined processing sites (1) using a laser processing device, wherein the laser processing device comprises
a. a laser radiation source (3) configured to generate a laser beam (L) and emit the laser beam (L) along an optical path (4) in a direction of the workpiece (2);
b. a beam splitting unit (5) located downstream of the laser radiation source (3) in said beam direction and configured to split the laser beam (L) into a bundle of partial beams (T); and
c. an optical control unit located downstream of the beam splitting unit (5) in the beam direction and comprising a reflective optical functional unit (8) including an array (14) of reflective microscanners (15), the optical control unit configured
to select from the bundle of partial beams (T) an arbitrary number of partial beams in an arbitrary spatial combination and direct them towards the workpiece (2), and
to position and/or move, within a predetermined partial beam scanning region (S_{T}) of a respective partial beam (T), at least one, of the partial beams (T) directed towards the workpiece (2) using a microscanner (15) of the array (14) of microscanners (15) assigned to the respective partial beam (T)
wherein the method further comprises
generating a laser beam (L) with the laser radiation source (3), and subsequent thereto, beam splitting the laser beam (L) into a bundle of partial beams (T), directing a predetermined number of partial beams (T) of the bundle of partial beams (T) in an arbitrary spatial combination towards the workpiece (2) at a predetermined number of sites using the optical control unit (6), and positioning and/or moving the predetermined number of partial beams (T) directed towards the workpiece (2) within a predetermined partial beam scanning region (S_{T}).

33. The method according to claim 32, further including, prior to the positioning and/or moving step, rough positioning the predetermined number of partial beams (T) directed towards the workpiece (2) at the predetermined number of sites by placing the workpiece (2) in a workpiece holder and
a. positioning the workpiece (2) relative to the laser processing device, or
b. positioning the partial beams (T), which are directed towards the workpiece (2) and located within a master scanning region (SM), relative to the workpiece (2) using a beam positioning unit (9), or
c. positioning the workpiece (2) relative to the laser processing device and the partial beams (T) directed towards the workpiece (2) and located within a master scanning region (S_{M}) with a beam positioning unit (9).

34. The method according to claim 33, further including, subsequent to the rough positioning and the positioning and/or moving steps, performing an individual scanning movement of at least some of the predetermined number of the partial beams using the optical control unit.

35. The method according to claim 33, further including performing, using the beam positioning unit (9), a simultaneous and synchronous scanning movement for the predetermined number of partial beams (T) directed towards the workpiece (2) subsequent to the rough positioning and the positioning and/or moving steps.

36. The method according to claim 33, further including performing, using the optical control unit and/or the beam positioning unit, a positioning correction of positioning errors for the predetermined number of the partial beams (T) directed towards the workpiece (2) subsequent to the rough positioning step and, when necessary, subsequent to the positioning and/or moving step.

37. The method according to claim 36, further including determining a correction matrix using an optical measuring system, and performing the positioning correction step using the correction matrix.

38. The method according to claim 33, further including, subsequent to the rough positioning and the positioning and/or moving steps, performing (i) an individual scanning movement of at least some of the predetermined number of the partial beams using the optical control unit, and (ii) using the beam positioning unit (9), a simultaneous and synchronous scanning movement along a predetermined scanning track for the predetermined number of partial beams (T) directed towards the workpiece (2) and, when carrying out the individual scanning movement using the optical control unit, performing a dynamic positioning correction of positioning errors for the predetermined number of the partial beams (T) directed towards the workpiece (2).

39. (canceled)
